(19) United States
(12) Patent Application Publication
(10) Pub. No.: US 2026/0093380 A1
(43) Pub. Date: Apr. 2, 2026

(54) METHODS, APPARATUSES AND COMPUTER PROGRAM PRODUCTS FOR GENERATING MACHINE LEARNING MODEL PREDICTED ISSUE CREATION USER INTERFACE

(71) Applicant: Atlassian Pty Ltd, Sydney (AU)

(72) Inventors: Marie CASABONNE, Oakland, CA (US); Michael KULINSKI, Los Angeles, CA (US); Nicole TOLLEFSON, Aptos, CA (US)

(21) Appl. No.: 18/902,443

(22) Filed: Sep. 30, 2024

(51) Int. Cl. G06F 3/0483; G06F 3/0482; G06F 9/451

(52) U.S. Cl. CPC G06F 3/0483; G06F 3/0482; G06F 9/451

(57) ABSTRACT

Various examples herein described are related to methods, apparatuses, and computer program products for generating contextualized user interfaces (including, but not limited to, contextual menu user interface components and machine learning predicted issue creation user interface components) in complex network computer systems.

### BACKGROUND

Applicant has identified many technical deficiencies and problems associated with generating user interfaces in complex network computer systems.

### BRIEF SUMMARY

In general, embodiments of the present disclosure provide methods, apparatuses, systems, computing devices, and/or the like for complex network computer systems such as, but not limited to, page collaboration and issue management platforms.

In accordance with various embodiments of the present disclosure, an apparatus is provided. In some embodiments, the apparatus comprises at least one processor and at least one non-transitory memory comprising program code. In some embodiments, the at least one non-transitory memory and the program code are configured to, with the at least one processor, cause the apparatus to at least: cause rendering a page data object user interface comprising a page content user interface component associated with a page data object; in response to receiving a user highlight input associated with the page content user interface component, cause rendering: an updated page content user interface component comprising one or more highlighted page content user interface elements and one or more unhighlighted page content user interface elements, and a contextual menu user interface component positioned adjacent to the one or more highlighted page content user interface elements and comprising an issue trigger user interface element, in response to receiving a user selection input associated with the issue trigger user interface element, cause rendering: a machine learning predicted issue creation user interface component comprising one or more machine learning model predicted issue metadata user interface elements based on the one or more highlighted page content user interface elements and the one or more unhighlighted page content user interface elements.

In some embodiments, the machine learning predicted issue creation user interface component is positioned adjacent to and does not obscure the updated page content user interface component.

In some embodiments, the one or more machine learning model predicted issue metadata user interface elements indicate predicted issue field metadata and predicted issue value metadata.

In some embodiments, the at least one non-transitory memory and the program code are configured to, with the at least one processor, cause the apparatus to: generate the predicted issue field metadata and the predicted issue value metadata based at least in part on one or more machine learning models, the one or more highlighted page content user interface elements and the one or more unhighlighted page content user interface elements.

In some embodiments, the one or more machine learning models are trained based on a plurality of historical page data objects and a plurality of historical issue data objects.

In some embodiments, the page data object user interface comprises a page hierarchy user interface component indicating at least one of a parent page data object, a sibling page data object, or a child page data object associated with the page data object.

In some embodiments, the one or more machine learning model predicted issue metadata user interface elements are further based on at least one of the parent page data object, the sibling page data object, or the child page data object.

In accordance with various embodiments of the present disclosure, a computer-implemented method is provided. In some embodiments, the computer-implemented method comprises: receiving a user highlight input associated with a page content user interface component of a page data object user interface associated with a page data object; in response to receiving the user highlight input, causing rendering: an updated page content user interface component comprising one or more highlighted page content user interface elements and one or more unhighlighted page content user interface elements, and a contextual menu user interface component comprising an issue trigger user interface element, receiving a user selection input associated with the issue trigger user interface element; in response to receiving the user selection input, causing rendering: a machine learning predicted issue creation user interface component comprising one or more machine learning model predicted issue metadata user interface elements based on the one or more highlighted page content user interface elements and the one or more unhighlighted page content user interface elements.

In some embodiments, the machine learning predicted issue creation user interface component is positioned adjacent to and does not obscure the updated page content user interface component.

In some embodiments, each of the one or more machine learning model predicted issue metadata user interface elements indicate predicted issue field metadata and predicted issue value metadata.

In some embodiments, the example computer-implemented method further comprises generating the predicted issue field metadata and the predicted issue value metadata based at least in part on one or more machine learning models, the one or more highlighted page content user interface elements and the one or more unhighlighted page content user interface elements.

In some embodiments, the one or more machine learning models are trained based on a plurality of historical page data objects and a plurality of historical issue data objects.

In some embodiments, the page data object user interface comprises a page hierarchy user interface component indicating at least one of a parent page data object, a sibling page data object, or a child page data object associated with the page data object.

In some embodiments, the one or more machine learning model predicted issue metadata user interface elements are further based on at least one of the parent page data object, the sibling page data object, or the child page data object.

In accordance with various embodiments of the present disclosure, a computer program product is provided. In some embodiments, the computer program product comprises at least one non-transitory computer-readable storage medium having computer-readable program code portions stored therein. In some embodiments, the computer-readable program code portions comprise an executable portion configured to: cause rendering a page data object user interface comprising a page content user interface component associated with a page data object; in response to receiving a user highlight input associated with the page content user interface component, cause rendering one or more highlighted page content user interface elements, one or more unhighlighted page content user interface elements, a contextual menu user interface component; and in response to receiving a user selection input associated with an issue trigger user interface element of the contextual menu user interface component, cause rendering a machine learning predicted issue creation user interface component comprising one or more machine learning model predicted issue metadata user interface elements.

In some embodiments, each of the one or more machine learning model predicted issue metadata user interface elements indicate predicted issue field metadata and predicted issue value metadata.

In some embodiments, the executable portion is configured to: generate the predicted issue field metadata and the predicted issue value metadata based at least in part on one or more machine learning models, the one or more highlighted page content user interface elements and the one or more unhighlighted page content user interface elements.

In some embodiments, the one or more machine learning models are trained based on a plurality of historical page data objects and a plurality of historical issue data objects.

In some embodiments, the page data object user interface comprises a page hierarchy user interface component indicating at least one of a parent page data object, a sibling page data object, or a child page data object associated with the page data object.

In some embodiments, the one or more machine learning model predicted issue metadata user interface elements are further based on at least one of the parent page data object, the sibling page data object, or the child page data object.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

Having thus described some embodiments in general terms, references will now be made to the accompanying drawings, which are not necessarily drawn to scale.

FIG. 1 is an example system architecture diagram illustrating an example page collaboration and issue management platform in communication with other devices (such as, but not limited to, client computing devices) in accordance with some embodiments of the present disclosure.

FIG. 2 is an example block diagram illustrating example components of an example apparatus in accordance with some embodiments of the present disclosure.

FIG. 3 is an example block diagram illustrating example components of an example apparatus in accordance with some embodiments of the present disclosure.

FIG. 4 is an example flow diagram illustrating example methods associated with generating example machine learning predicted issue creation user interface components in accordance with some embodiments of the present disclosure.

FIG. 5 is an example visualization view illustrating an example page content user interface component on an example page data object user interface in accordance with some embodiments of the present disclosure.

FIG. 6A is an example visualization view illustrating an example updated page content user interface component and an example contextual menu user interface component on an example page data object user interface in accordance with some embodiments of the present disclosure.

FIG. 6B is an example visualization view illustrating an example updated page content user interface component and an example contextual menu user interface component on an example page data object user interface in accordance with some embodiments of the present disclosure.

FIG. 7A is an example visualization view illustrating an example contextual menu user interface component in accordance with some embodiments of the present disclosure.

FIG. 7B is an example visualization view illustrating an example contextual menu user interface component in accordance with some embodiments of the present disclosure.

FIG. 7C is an example visualization view illustrating an example contextual menu user interface component in accordance with some embodiments of the present disclosure.

FIG. 8 is an example flow diagram illustrating example methods associated with generating example machine learning predicted issue creation user interface components in accordance with some embodiments of the present disclosure.

FIG. 9 is an example flow diagram illustrating example methods associated with training an example machine learning model to generate example predicted issue field metadata and example predicted issue value metadata in accordance with some embodiments of the present disclosure.

FIG. 10A is an example visualization view illustrating an example updated page content user interface component and an example machine learning predicted issue creation user interface component on an example page data object user interface in accordance with some embodiments of the present disclosure.

FIG. 10B is an example visualization view illustrating an example updated page content user interface component and an example machine learning predicted issue creation user interface component on an example page data object user interface in accordance with some embodiments of the present disclosure.

FIG. 10C is an example visualization view illustrating an example updated page content user interface component and an example machine learning predicted issue creation user interface component on an example page data object user interface in accordance with some embodiments of the present disclosure.

FIG. 10D is an example visualization view illustrating an example updated page content user interface component and an example machine learning predicted issue creation user interface component on an example page data object user interface in accordance with some embodiments of the present disclosure.

FIG. 10E is an example visualization view illustrating an example updated page content user interface component and an example machine learning predicted issue creation user interface component on an example page data object user interface in accordance with some embodiments of the present disclosure.

FIG. 11 is an example flow diagram illustrating example methods associated with generating an example updated page content user interface component in accordance with some embodiments of the present disclosure.

FIG. 12A is an example visualization view illustrating an example updated page content user interface component on an example page data object user interface in accordance with some embodiments of the present disclosure.

FIG. 12B is an example visualization view illustrating an example updated page content user interface component on an example page data object user interface in accordance with some embodiments of the present disclosure.

FIG. 12C is an example visualization view illustrating an example updated page content user interface component on an example page data object user interface in accordance with some embodiments of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as “comprises,” “includes,” and “having” should be understood to provide support for narrower terms such as “consisting of,” “consisting essentially of,” and “comprised substantially of.”

The phrases “in one embodiment,” “according to one embodiment,” “in some examples,” “for example,” and the like generally mean that the particular feature, structure, or characteristic following the phrase may be included in an embodiment of the present disclosure, and may be included in more than one embodiment of the present disclosure (importantly, such phrases do not necessarily refer to the same embodiment).

### Overview

Various embodiments of the present disclosure relate generally to methods, apparatuses, systems, computing devices, and/or the like for generating machine learning predicted user interfaces in complex network computer systems.

For example, such complex network computer systems may include a page system that allows users to collaboratively create, edit and share pages (for example, documents). As an example, the page system may be implemented in the context of software development by a team of software developers. In such an example, the page system may provide tools for the team of software developers to collaboratively create, edit, and share pages that describe or provide content and information such as, but not limited to, technical specifications related to software features, ideas from brainstorming sessions, and/or the like. The page system may also provide simultaneous editing capacities, such that edits made by one software developer on a page are reflected in real-time on the page displayed to other software developers, such that the team of software developers all have the most up-to-date version of the page.

As another example, such complex network systems may include an issue system that allows users to create, track, and assign issues (for example, tasks). Continuing from the software development context above, the issue system may provide tools for the team of software developers to track, prioritize, and manage issues that outline or specify tasks related to, such as, but not limited to, fixing software bugs, adding new software features, and/or the like. The issue system may also provide capabilities to assign tasks to one or more members of the team, such as that each team member can work on specific tasks for software development.

However, there are many technical problems, challenges, and difficulties associated with page systems and issue systems.

Continuing from the software development context above, a page system may comprise pages that describe technical requirements for a new software feature. To develop this new software feature, multiple tasks may need to be created, tracked, and completed (such as, but not limited to, writing programming code for the new software feature, updating an existing user interface to add user interface elements for the new software feature, revising software logic to incorporate the new software feature, and/or the like). However, many page systems do not provide issue management functionalities. As a result, a software developer needs to manually obtain information from a page system, switch to an issue system, and then type in information to the issue system to create a new issue, resulting in the software developer losing context from the page system when using the issue system. For example, a page from the page system may list a dozen or more new software features, and each new software feature may require a dozen or more tasks to be completed in order to be developed. In this example, the software developer is required to manually repeats the steps (obtaining information from the page system, switching to an issue system, and then typing in information to the issue system) over a hundred of times, causing the software developer to easily lose context associated with each task as described in the page system. The above technical difficulties and challenges are amplified when there are thousands or hundreds of thousands of tasks to be created. The limitations in those systems cause not only inefficiency and computing resources constrain, but also high probabilities that human errors are introduced in manually created issues.

Various embodiments of the present disclosure overcome these technical challenges and difficulties, and provide various technical improvements. For example, various embodiments of the present applications provide a page collaboration and issue management platform that not only improves functionalities of page collaboration systems and issue management systems, but also provide machine learning predicted user interfaces that improve user experience.

In the present disclosure, the term “page collaboration and issue management platform” refers to a cloud-based computing platform for providing a collaborative work environment and comprising a page collaboration system and an issue management system.

In the present disclosure, the term “page collaboration system” refers to a cloud-based computing system that allows users to collaboratively create, edit and share pages (such as, but not limited to, digital documents that includes texts, tables, images, audio data, video data, and/or the like).

In the present disclosure, the term “issue management system” refers to a cloud-based computing system that allows users to create, track, and assign issues (such as, but not limited to, tasks, to-dos, and/or the like).

In some embodiments, the page collaboration and issue management platform provide functionalities that connect page data objects in the page collaboration system to issue data objects in the issue management platform, thereby improving the functionalities of standalone page systems and issue systems.

In addition, various embodiments of the present disclosure provide user interfaces that improve user experience. For example, some embodiments of the present disclosure may cause rendering an example contextual menu user interface component when a user highlights contents on a page data object user interface. In such an example, the example contextual menu user interface component may include an issue trigger user interface element. After the user selects the issue trigger user interface element, the page data object user interface to include a machine learning predicted issue creation user interface component, which includes predicted issue field metadata and predicted issue value metadata for generating an issue data object in the issue management system. Because the machine learning predicted issue creation user interface component is displayed side by side with the page content user interface component, a user may edit the issue field metadata and issue value metadata without losing the context from the page content. As such, example user interfaces of the present disclosure improve user experience.

Further, various embodiments of the present disclosure provide machine learning model based mechanisms for generating example user interfaces described herein to improve user experiences. For example, various examples of the present disclosure provide example methods for training such machine learning models to predict issue field metadata and issue value metadata, therefore providing technical advantages such as improved accuracy in predicting issue field metadata and issue value metadata to be rendered on example machine learning predicted issue creation user interface components.

Additional technical details highlighting these technical benefits and improvements are described further herein.

### Definitions

In the present disclosure, the terms “set,” “subset,” and similar terms refer to a collection of zero or more elements.

In the present disclosure, the terms “data,” “content,” “digital content,” “digital content object,” “information,” and similar terms may be used interchangeably to refer to data capable of being transmitted, received, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like (sometimes referred to herein as a “network”). Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

In the present disclosure, the term “circuitry” should be understood broadly to include hardware and, in some examples, software for configuring the hardware. With respect to components of the apparatus, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like.

In some embodiments, the term “user computing device” refers to a computing device that is operated by a user entity to access an example page collaboration and issue management platform in accordance with some embodiments of the present disclosure. In some embodiments, a user entity may include individual users, organizations, enterprises, and/or the like. In some embodiments, user computing devices may include, but not limited to, desktop computers, workstations, portable digital assistant devices, mobile telephones, smartphones, laptop computers, tablet computers, wearables, or any combination of the aforementioned devices.

In some embodiments, the term “data object” refers to structured data that represents, provides, and/or describes information, content, functionalities and/or characteristics associated with information and/or content. In some embodiments, the term “metadata” refers to a parameter, a data field, a data element, a data attribute, a data property, and/or the like that is a part of one or more data objects, requests, responses, and/or the like. In some embodiments, example data objects and/or example metadata may be embodied in forms such as, but not limited to, binary codes, American Standard Code for Information Interchange (ASCII) codes, memory addresses or pointers to memory addresses in data storage devices, and/or the like.

In some embodiments, the term “page data object” refers to a type of data object that represents, provides, and/or describes data and content related to one or more digital documents that comprise such, but not limited to, texts, tables, images, audio data, video data, links, interactive data objects (such as, but not limited to, plugins and macros) and/or the like. In some embodiments, an example page data object may be embodied in forms such as, but not limited to, binary codes, ASCII codes, memory addresses or pointers to memory addresses in data storage devices, and/or the like.

In some embodiments, example page data objects may be organized into a hierarchy structure based on factors such as, but not limited to, relevance, importance, priority and/or the like. For example, an example page data object may be associated with a child page data object that is at a lower hierarchy level than the hierarchy level of the example page data object. Additionally, or alternatively, an example page data object may be associated with a sibling page data object that is at the same hierarchy level as the hierarchy level of the example page data object. Additionally, or alternatively, an example page data object may be associated with a parent page data object that is at a higher hierarchy level than the hierarchy level of the example page data object.

In some embodiments, the term “issue data object” refers to a type of data object that represents, provides, and/or describes data and content related to one or more tasks, one or more to-dos, and/or the like. In some embodiments, an example issue data object may be embodied in forms such as, but not limited to, binary codes, ASCII codes, memory addresses or pointers to memory addresses in data storage devices, and/or the like.

In some embodiments, example data objects of the present disclosure may be rendered on one or more user interfaces that can be displayed on a display. For example, the term “page data object user interface” refers to a user interface that displays, illustrates, and/or indicates data and/or information associated with an example page data object.

In some embodiments, example page data object user interfaces may comprise one or more user interface components. For example, an example page data object user interface in accordance with some embodiments of the present disclosure may comprise one or more user interface components such as, but not limited to, an example page hierarchy user interface component, an example page content user interface component, an example contextual menu user interface component, an example machine learning predicted issue creation user interface component, and/or the like.

In some embodiments, the term “page hierarchy user interface component” refers to a component on a user interface that displays, illustrates, and/or indicates data and/or information associated with the hierarchy of an example page data object. For example, an example page hierarchy user interface component may display, illustrate, and/or indicate one or more child page data objects associated with the example page data object. Additionally, or alternatively, the example page hierarchy user interface component may display, illustrate, and/or indicate one or more sibling page data objects associated with the example page data object. Additionally, or alternatively, the example page hierarchy user interface component may display, illustrate, and/or indicate one or more parent page data objects associated with the example page data object.

In some embodiments, the term “page content user interface component” refers to a component on a user interface that displays, illustrates, and/or indicates data and/or information associated with the content of an example page data object. For example, an example page content user interface component may display, illustrate, and/or indicate texts, tables, images, audio data, video data, links, and/or the like of the example page content user interface component.

In some embodiments, a user may provide one or more user inputs through an example user interface. For example, a user may provide a user highlight input associated with an example page content user interface component. In some embodiments, the term “user highlight input” refers to a user input that indicates a selection of a portion of content displayed on the example page content user interface component (for example, a user may drag a pointer such as a mouse course or use keyboard command to select text, tables, images, and/or the like on the example page content user interface component.

In some embodiments, an example user interface component may comprise one or more user interface elements. For example, in response to the user providing a user highlight input, the example page content user interface component may be updated to include one or more highlighted page content user interface elements and one or more unhighlighted page content user interface elements.

In some embodiments, the term “highlighted page content user interface element” refers to a user interface element that displays, illustrates, and/or indicates content that is selected by the user on the example page content user interface component based on the user highlight input. For example, the highlighted page content user interface element may comprise the selected content by the user highlight input with a background color that visually distinguishes the selected content from the surrounding content. Additionally, or alternatively, the highlighted page content user interface element may comprise the selected content by the user highlight input with its text font or style that visually distinguishes the selected content from the surrounding content. Additionally, or alternatively, the highlighted page content user interface element may comprise the selected content that is visually distinguished from content that is not selected by the user highlight input.

In some embodiments, the term “unhighlighted page content user interface element” refers to a user interface element that displays, illustrates, and/or indicates content that is not selected by the user on the example page content user interface component based on the user highlight input. For example, the unhighlighted page content user interface element may comprise content not selected by the user with visual features (for example, background color, font, style, etc.) that are different from those of content selected by the user.

In some embodiments, the term “contextual menu user interface component” refers to a component on a user interface that displays, illustrates, and/or indicates data and/or information associated with one or more operation options based at least in part on the content selected by the user. For example, an example contextual menu user interface component in accordance with some embodiments of the present disclosure may comprise an issue trigger user interface element. In some embodiments, the term “issue trigger user interface element” refers to an element of the contextual menu user interface component that displays, illustrates, and/or indicates data and/or information associated with a command to trigger the generation of an issue data object.

In some embodiments, a user may provide an example user selection input of an example contextual menu user interface component. In some embodiments, the term “user selection input” refers to a user input that indicates a selection of a user interface element (for example, a user may click a pointer such as a mouse or use keyboard command to indicate a selection of the example contextual menu user interface component).

In some embodiments, the term “machine learning predicted issue creation user interface component” refers to a component on a user interface that displays, illustrates, and/or indicates data and/or information that is predicted by one or more machine learning models and associated with generating one or more issue data objects based on one or more page data objects. In some embodiments, an example machine learning predicted issue creation user interface component may display, illustrate, and/or indicate data and/or information associated with predictive outputs from one or more machine learning models.

For example, an example machine learning predicted issue creation user interface component in accordance with some embodiments of the present disclosure may display, illustrate, and/or indicate predicted issue field metadata. In some embodiments, the term “predicted issue field metadata” refers to metadata predicted by one or more machine learning models that indicates one or more data fields for an issue data object. For example, an example issue data object may comprise field metadata such as, but not limited to, project, issue type, summary, assignee, description, and/or the like. In such an example, each field metadata represents an attribute or label in the data structure of the example issue data object. In some embodiments, an example machine learning predicted issue creation user interface component may display, illustrate, and/or indicate issue field metadata that are predicted by one or more machine learning models to be relevant for an issue data object to be generated based on a page data object. Additional examples of predicted issue field metadata are illustrated and described herein.

Additionally, or alternatively, an example machine learning predicted issue creation user interface component in accordance with some embodiments of the present disclosure may display, illustrate, and/or indicate predicted issue value metadata. In some embodiments, the term “predicted issue value metadata” refers to metadata predicted by one or more machine learning models that indicates one or more data values for an issue data object. For example, an example issue data object may comprise one or more value metadata for one or more field metadata. As an example, an example issue data object may comprise a value metadata for the field metadata “project” that indicates a name of a project that the example issue data object belongs to. In some embodiments, an example machine learning predicted issue creation user interface component may display, illustrate, and/or indicate one or more issue value metadata that are predicted by one or more machine learning models for an issue data object to be generated based on a page data object. Additional examples of predicted issue value metadata are illustrated and described herein.

In some embodiments, one or more example machine learning models may be trained based on one or more historical issue data objects and one or more historical page data objects. In some embodiments, each historical issue data object is generated based at least in part on one or more historical page data objects. Additional details associated with historical issue data objects, historical page data objects, and training the one or more example machine learning models are described herein.

### Example System Architecture for Implementing Embodiments of the Present Disclosure

Methods, apparatuses, and computer program products of the present disclosure may be embodied by any of a variety of devices. For example, example methods, apparatuses, and computer program products of example embodiments may be embodied by a networked computing device (for example, but not limited to, a network server in an example page collaboration and issue management platform). Additionally, or alternatively, example methods, apparatuses, and computer program products of example embodiments may be embodied by fixed computing devices, such as a personal computer or a computer workstation. Additionally, or alternatively, example methods, apparatuses, and computer program products of example embodiments may be embodied by any of a variety of mobile devices such as, but not limited to, portable digital assistants, mobile telephones, smartphones, laptop computers, tablet computers, wearables, or any combination of the aforementioned devices.

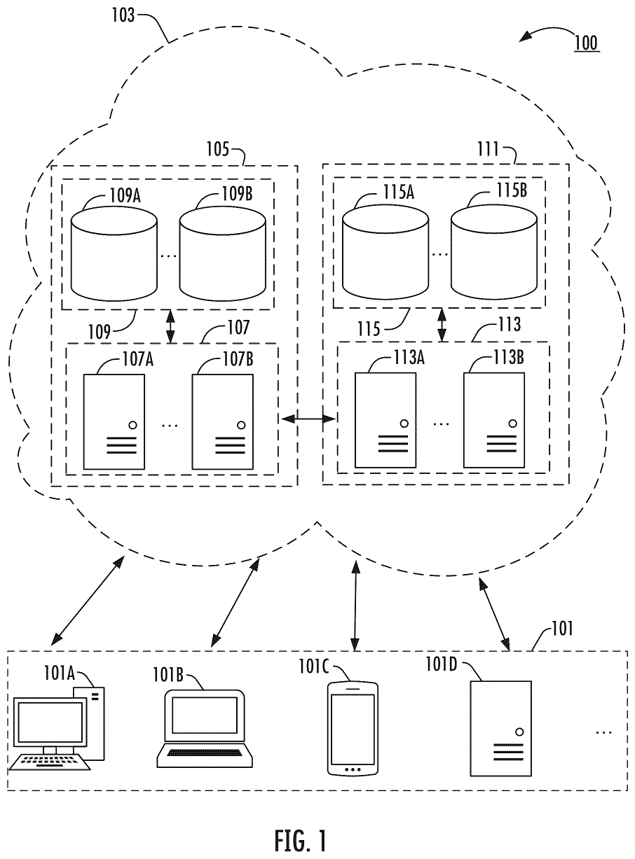

Referring now to FIG. 1, an example system architecture diagram illustrates an example cloud-based computing environment 100 within which embodiments of the present disclosure may operate.

In the example shown in FIG. 1, the cloud-based computing environment 100 may comprise an example page collaboration and issue management platform 103 in electronic communication with one or more user computing devices (such as, but not limited to, one or more client computing devices 101) via one or more networks (such as, but not limited to, one or more local area networks, one or more wide area networks, and/or the like).

In the example shown in FIG. 1, the one or more client computing devices 101 include, but are not limited to, client computing device 101A, client computing device 101B, client computing device 101C, and client computing device 101D. In some embodiments, the one or more client computing devices 101 may comprise computing devices including, but not limited to, desktop computers, laptop computers, smartphones, netbooks, tablet computers, wearables, servers, and the like.

In some embodiments, each of the one or more client computing devices 101 may be operated by a user of the example page collaboration and issue management platform 103. In some embodiments, each of the one or more client computing devices 101 may provide user inputs to the example page collaboration and issue management platform 103 such as, but not limited to, user highlight inputs, user selection inputs, user confirmation inputs, and/or the like.

While FIG. 1 illustrates example client computing devices, it is noted that the scope of the present disclosure is not limited to the example illustrated in FIG. 1. In some examples, an example page collaboration and issue management platform may communicate with less than or more than the number of example client computing devices illustrated in FIG. 1, and/or may additionally or alternatively comprise other types of computing devices that operate as client computing devices.

In some embodiments, the one or more client computing devices 101 may communicate with the example page collaboration and issue management platform 103 though one or more data communication networks. Example data communication networks in accordance with some embodiments of the present disclosure may include, but not limited to, cable networks, public networks (e.g., the Internet), private networks (e.g., frame-relay networks), wireless networks, cellular networks, telephone networks (e.g., a public switched telephone network), or any other suitable private and/or public networks. Additionally, or alternatively, example data communication networks in accordance with some embodiments of the present disclosure may have any suitable communication range associated therewith and may include, for example, global networks, metropolitan area networks (MANs), wide area networks (WANs), local area networks (LANs), personal area networks (PANs), and/or the like. Additionally, or alternatively, example data communication networks in accordance with some embodiments of the present disclosure may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities. Additionally, or alternatively, example data communication networks in accordance with some embodiments of the present disclosure may utilize a variety of networking protocols including, but not limited to, transmission control protocol/internet protocol (TCP/IP) based networking protocols, custom protocols of JavaScript Object Notation (JSON) objects sent via a WebSocket channel, JSON over remote procedure call (RPC), JSON over representational state transfer/hypertext transfer protocol (REST/HTTP), and/or the like.

In some embodiments, the example page collaboration and issue management platform 103 may comprise an example page collaboration system 105 and an example issue management system 111. In some embodiments, each of the example page collaboration system 105 and the example issue management system 111 may comprise one or more network computing devices and one or more data storage devices.

In the example shown in FIG. 1, the example page collaboration system 105 may comprise one or more network computing devices 107 (such as, but not limited to, network computing device 107A, network computing device 107B, and/or the like) and one or more data storage devices 109 (such as, but not limited to, data storage device 109A, data storage device 109B, and/or the like).

In some embodiments, the one or more network computing devices 107 may comprise computing devices including, but not limited to, network servers (such as, but not limited to, web servers, proxy servers, virtual machines, file transfer protocol (FTP) servers, application servers, file servers, and/or the like), cloud computing networks (including, but not limited to, private cloud computing networks, public cloud computing networks, hybrid cloud computing networks, and/or the like), mainframe computers, desktop computers, laptop computers, and/or the like.

In some embodiments, the one or more data storage devices 109 may include, but are not limited to, data storage device 109A and data storage device 109B. In some embodiments, the one or more data storage devices 109 may comprise data storage devices including, but not limited to, network data storages (such as, but not limited to, directly attached storage (DAS), network attached storage (NAS), storage area network (SAN), and/or the like), local data storages (such as, but not limited to, random access memory (RAM), hard disk drive (HDD), solid-state drive (SSD), and/or the like), removable data storages (such as, but not limited to, portable hard drives), database servers, and/or the like.

In some embodiments, the one or more network computing devices 107 are in electronic communications with the one or more data storage devices 109. In some embodiments, the one or more network computing devices 107 may generate one or more page data objects, transmit one or more page data objects to the one or more data storage devices 109 for storage, access one or more page data objects from the one or more data storage devices 109, modify one or more page data objects, and/or the like.

In the example shown in FIG. 1, the example issue management system 111 may comprise one or more network computing devices 113 (such as, but not limited to, network computing device 113A, network computing device 113B, and/or the like) and one or more data storage devices 115 (such as, but not limited to, data storage device 115A, data storage device 115B, and/or the like).

In some embodiments, the one or more network computing devices 113 may comprise computing devices including, but not limited to, network servers (such as, but not limited to, web servers, proxy servers, virtual machines, FTP servers, application servers, file servers, and/or the like), cloud computing networks (including, but not limited to, private cloud computing networks, public cloud computing networks, hybrid cloud computing networks, and/or the like), mainframe computers, desktop computers, laptop computers, and/or the like.

In some embodiments, the one or more data storage devices 115 may include, but are not limited to, data storage device 115A and data storage device 115B. In some embodiments, the one or more data storage devices 115 may comprise data storage devices including, but not limited to, network data storages (such as, but not limited to, DAS, NAS, SAN, and/or the like), local data storages (such as, but not limited to, RAM, HDD, SSD, and/or the like), removable data storages (such as, but not limited to, portable hard drives), database servers, and/or the like.

In some embodiments, the one or more network computing devices 113 are in electronic communications with the one or more data storage devices 115. In some embodiments, the one or more network computing devices 113 may generate one or more issue data objects, transmit one or more issue data objects to the one or more data storage devices 115 for storage, access one or more page data objects from the one or more data storage devices 115, modify one or more issue data objects, and/or the like.

It is noted that various components of the example page collaboration and issue management platform 103 may leverage the same computer or computing apparatus to perform various operations. For example, one or more components of one or more network computing devices (such as, but not limited to, network computing devices 107 and/or network computing devices 113) in the example page collaboration and issue management platform 103 may leverage the same computer or computing apparatus to perform various operations.

### Example Apparatuses for Implementing Embodiments of the Present Disclosure

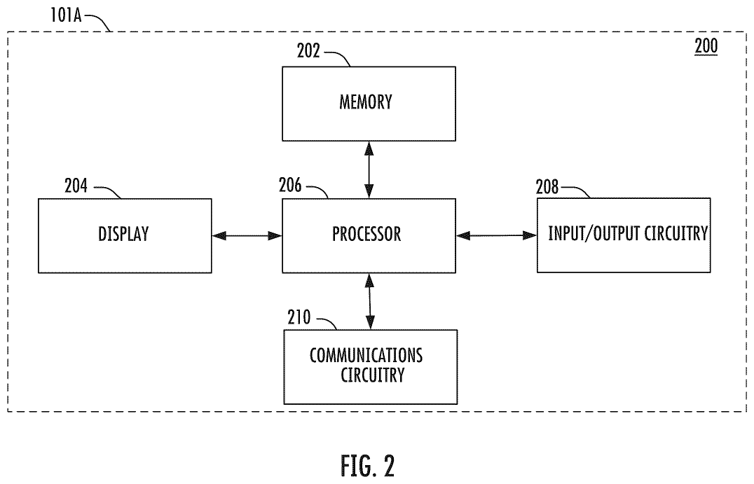

Referring now to FIG. 2, an example block diagram illustrates example components of an example apparatus in accordance with some embodiments of the present disclosure. For example, example user computing devices in various embodiments of the present disclosure (for example, the example client computing devices 101 in FIG. 1) may include one or more computing systems, such as the apparatus 200 shown in FIG. 2.

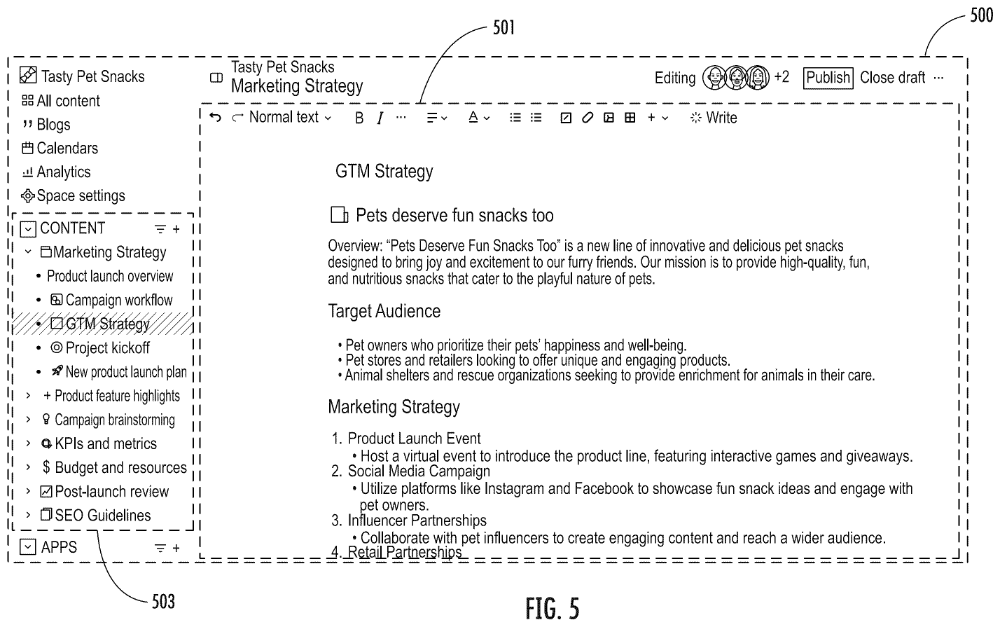

In some embodiments, the apparatus 200 may be configured to execute at least some of the operations described above with respect to FIG. 1 and below with respect to FIG. 5 to FIG. 12C. In some embodiments, the apparatus 200 may include a processor 206, a memory 202, an input/output circuitry 208, a communications circuitry 210, and/or a display 204.

Although the processor 206, the memory 202, the input/output circuitry 208, the communications circuitry 210, and the display 204 may be described with respect to their functions, it should be understood that the particular implementations necessarily include the use of particular hardware. It should also be understood that certain of the processor 206, the memory 202, the input/output circuitry 208, the communications circuitry 210, and/or the display 204 may include similar or common hardware. For example, two sets of circuitries may both leverage use of the same processor, network interface, storage medium, or the like to perform their associated functions, such that duplicate hardware is not required for each set of circuitries.

In some embodiments, the apparatus 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitries may both leverage use of the same processor, network interface, storage medium, or the like to perform their associated functions, such that duplicate hardware is not required for each set of circuitries. The use of the term “circuitry” as used herein with respect to components of the apparatus should therefore be understood to include particular hardware configured to perform the functions associated with the particular circuitry as described herein.

In some embodiments, the processor 206 (and/or co-processor or any other processing circuitry assisting or otherwise associated with the processor) may be in communication with the memory 202 via a bus for passing information among components of the apparatus. In some embodiments, the memory 202 is non-transitory and may include, for example, one or more volatile and/or non-volatile memories. In some embodiments, for example, the memory 202 may be an electronic storage device (e.g., a computer readable storage medium). In some embodiments, the memory 202 may be configured to store information, data, content, applications, instructions, or the like, for enabling the apparatus 200 to carry out various functions in accordance with example embodiments of the present disclosure.

In some embodiments, the processor 206 may be embodied in a number of different ways and may, for example, include one or more processing devices configured to perform independently. Additionally, or alternatively, the processor 206 may include one or more processors configured in tandem via a bus to enable independent execution of instructions, pipelining, and/or multithreading. In some embodiments, the use of the term “processing circuitry” may be understood to include a single core processor, a multi-core processor, multiple processors internal to the apparatus, and/or remote or “cloud” processors.

In an example embodiment, the processor 206 may be configured to execute instructions stored in the memory 202 or otherwise accessible to the processor. Alternatively, or additionally, the processor 206 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 206 is embodied as an executor of software instructions, the instructions may specifically configure the processor to perform the algorithms and/or operations described herein when the instructions are executed.

In some embodiments, the apparatus 200 may include the input/output circuitry 208 that may, in turn, be in communication with the processor 206 to provide output to the user and, in some embodiments, to receive an indication of a user input. The input/output circuitry 208 may comprise a user interface circuitry and may include a display, which may comprise a web user interface, a mobile application, a user computing device, a kiosk, or the like. In some embodiments, the input/output circuitry 208 may also include a keyboard, a mouse, a joystick, a touch screen, touch areas, soft keys, a microphone, a speaker, or other input/output mechanisms. In some embodiments, the processor and/or user interface circuitry comprising the processor may be configured to control one or more functions of one or more user interface elements through computer program instructions (e.g., software and/or firmware) stored on a memory accessible to the processor (e.g., the memory 202, and/or the like).

In some embodiments, the apparatus 200 may include the display 204 that may, in turn, be in communication with the processor 206 to display renderings of various user interfaces. In various examples of the present disclosure, the display 204 may include a liquid crystal display (LCD), a light-emitting diode (LED) display, a plasma (PDP) display, a quantum dot (QLED) display, and/or the like.

In some embodiments, the communications circuitry 210 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 210 may include, for example, a network interface for enabling communications with a wired or wireless communication network. For example, the communications circuitry 210 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

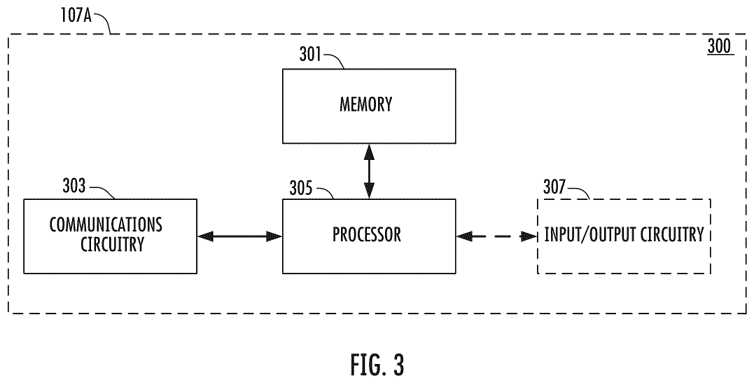

Referring now to FIG. 3, an example block diagram illustrates example components of an example apparatus in accordance with some embodiments of the present disclosure. For example, example network computing devices in various embodiments of the present disclosure (for example, the one or more network computing devices 107 and/or the one or more network computing devices 113 in FIG. 1) may include one or more computing systems, such as the apparatus 300 shown in FIG. 3.

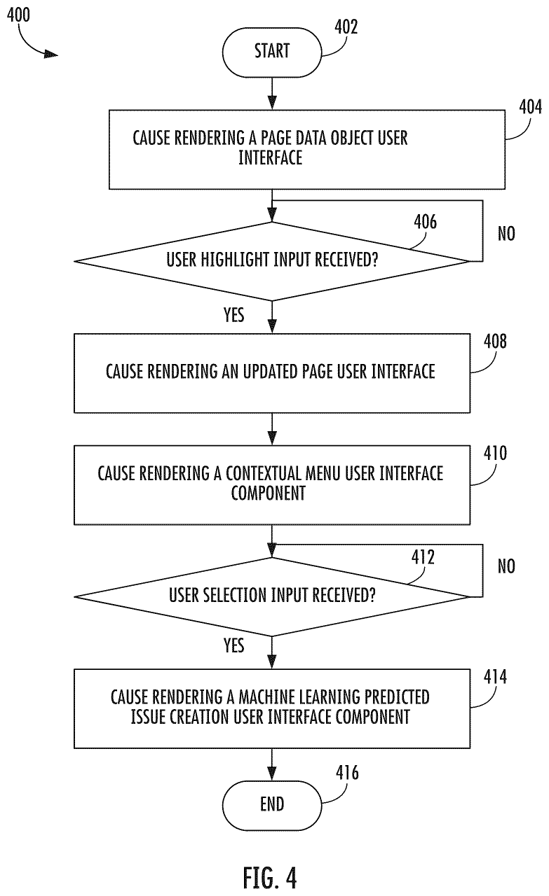

In some embodiments, the apparatus 300 may be configured to execute at least some of the operations described above with respect to FIG. 1 and below with respect to FIG. 4 to FIG. 12C. In some embodiments, the apparatus 300 may include a processor 305, a memory 301, an input/output circuitry 307, and a communications circuitry 303.

Although the processor 305, the memory 301, the input/output circuitry 307, and the communications circuitry 303 may be described with respect to their functions, it should be understood that the particular implementations necessarily include the use of particular hardware. It should also be understood that certain of the processor 305, the memory 301, the input/output circuitry 307, and/or the communications circuitry 303 may include similar or common hardware. For example, two sets of circuitries may both leverage use of the same processor, network interface, storage medium, or the like to perform their associated functions, such that duplicate hardware is not required for each set of circuitries.

In some embodiments, the processor 305 (and/or co-processor or any other processing circuitry assisting or otherwise associated with the processor) may be in communication with the memory 301 via a bus for passing information among components of the apparatus. In some embodiments, the memory 301 is non-transitory and may include, for example, one or more volatile and/or non-volatile memories. In some embodiments, for example, the memory 301 may be an electronic storage device (e.g., a computer-readable storage medium). In some embodiments, the memory 301 may be configured to store information, data, content, applications, instructions, or the like for enabling the apparatus to carry out various functions in accordance with example embodiments of the present disclosure.

In some embodiments, the processor 305 may be embodied in a number of different ways and may, for example, include one or more processing devices configured to perform independently. In some examples, the processor 305 may include one or more processors configured in tandem via a bus to enable independent execution of instructions, pipelining, and/or multithreading. The use of the term “processor” or “processing circuitry” may be understood to include a single core processor, a multi-core processor, multiple processors internal to the apparatus, and/or remote or “cloud” processors.

In some embodiments, the processor 305 may be configured to execute instructions stored in the memory 301 or otherwise accessible to the processor 305. In some examples, the processor 305 may be configured to execute hard-coded functionalities. In some embodiments, whether configured by hardware or software methods, or by a combination thereof, the processor 305 may represent an entity (e.g., physically embodied in circuitry) capable of performing operations according to an embodiment of the present disclosure while configured accordingly. In some embodiments, when the processor 305 is embodied as an executor of software instructions, the instructions may specifically configure the processor 305 to perform the algorithms and/or operations described herein when the instructions are executed.

In some embodiments, the apparatus 300 may optionally include the input/output circuitry 307 that may, in turn, be in communication with the processor 305 to provide output to the user and, in some embodiments, to receive an indication of a user input. In some embodiments, the input/output circuitry 307 may comprise a user interface circuitry and may include a display, which may comprise a web user interface, a mobile application, a user computing device, a kiosk, or the like. In some embodiments, the input/output circuitry 307 may include a keyboard, a mouse, a joystick, a touch screen, touch areas, soft keys, a microphone, a speaker, or other input/output mechanisms. In some embodiments, the processor and/or user interface circuitry comprising the processor may be configured to control one or more functions of one or more user interface elements through computer program instructions (e.g., software and/or firmware) stored on a memory accessible to the processor (e.g., the memory 301, and/or the like).

In some embodiments, the communications circuitry 303 may be any means such as a device or circuitry embodied in either hardware or a combination of hardware and software that is configured to receive and/or transmit data from/to a network and/or any other device, circuitry, or module in communication with the apparatus 300. In some embodiments, the communications circuitry 303 may include, for example, a network interface for enabling communications with a wired or wireless communication network (such as the communication network described above in connection with FIG. 1). In some embodiments, the communications circuitry 303 may include one or more network interface cards, antennae, buses, switches, routers, modems, and supporting hardware and/or software, or any other device suitable for enabling communications via a network. In some embodiments, the communications circuitry 303 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

In some embodiments, other elements of the apparatus 300 may provide or supplement the functionality of particular circuitry. For example, the processor 305 may provide processing functionality, the memory 301 may provide storage functionality, the communications circuitry 303 may provide network interface functionality, and the like. As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

### Example Methods for Implementing Embodiments of the Present Disclosure

Various example methods described herein, including, for example, those as shown in FIG. 4 to FIG. 12C, may provide various technical advantages and/or improvements described above.

It is noted that each block of the flowchart, and combinations of blocks in the flowchart, may be implemented by various means such as hardware, firmware, circuitry and/or other devices associated with execution of software including one or more computer program instructions. For example, one or more of the methods described in FIG. 4 to FIG. 12C may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

### Example Generation of Machine Learning Predicted Issue Creation User Interface Components

Referring now to FIG. 4, an example flow diagram illustrating example methods associated with generating example machine learning predicted issue creation user interface components in accordance with some embodiments of the present disclosure is provided.

For example, example methods illustrated in FIG. 4 resolve technical issues associated with page systems and issue systems and improve the functioning of page collaboration and issue management platforms by generating machine learning predicted issue creation user interface components. As such, example machine learning predicted issue creation user interface components in accordance with example methods illustrated in FIG. 4 improve speed of generating issue data objects based on page data objects, as well as usability of example page collaboration and issue management platforms in accordance with some embodiments of the present disclosure.

In the example shown in FIG. 4, an example method 400 starts at step/operation 402 and then proceeds to step/operation 404. At step/operation 404, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering a page data object user interface.

In some embodiments, the page data object user interface comprises a page content user interface component associated with a page data object. As described above, an example page content user interface in accordance with some embodiments of the present disclosure may display, illustrate, and/or indicate data and/or information associated with the content of an example page data object. For example, the example page content user interface may display, illustrate, and/or indicate one or more texts from and/or associated with the example page data object. Additionally, or alternatively, the example page content user interface may display, illustrate, and/or indicate one or more images from and/or associated with the example page data object. Additionally, or alternatively, the example page content user interface may display, illustrate, and/or indicate one or more tables from and/or associated with the example page data object. Additionally, or alternatively, the example page content user interface may display, illustrate, and/or indicate audio data from and/or associated with the example page data object. Additionally, or alternatively, the example page content user interface may display, illustrate, and/or indicate video data from and/or associated with the example page data object. Additionally, or alternatively, the example page content user interface may display, illustrate, and/or indicate link data from and/or associated with the example page data object. Additionally, or alternatively, the example page content user interface may display, illustrate, and/or indicate other information and/or data associated with the example page data object.

In some embodiments, the page data object user interface may be in an edit mode. In such examples, the page data object user interface display user interface components and elements that enable a user to modify content associated with the page data object. For example, the page data object user interface in the edit mode includes user interface components and elements for triggering modification of font size, font style, paragraph format, and/or the like.

In some embodiments, the page data object user interface may be in a view mode. In such examples, the page data object user interface does not display user interface components and elements that would enable a user to modify content associated with the page data object. For example, the page data object user interface in the view mode allows a user to navigate the content associated with the page data object without the risks of accidental modifications on the content associated with the page data object.

Referring back to FIG. 4, subsequent and/or in response to step/operation 404, the example method 400 proceeds to step/operation 406. At step/operation 406, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) determines whether a user highlight input is received.

As described above, a user highlight input may indicate a selection of a portion of content displayed on the example page content user interface component by a user. For example, an example user highlight input may be generated based on user interactions with a computer mouse. In such an example, the user may position the mouse cursor at the beginning of the portion of content that the user would like to select on the example page content user interface, click and hold the left mouse button, drag the cursor to the end of the portion of content that the user would like to select, and then release the left mouse button. Additionally, or alternatively, an example user highlight input may be generated based on user interactions with a computer keyboard. For example, the user may use one more keyboard shortcuts to indicate the portion of the content that the user would like to select. Additionally, or alternatively, the example page content user interface component may be rendered on a touch screen, and the user highlight input may be generated based on user interactions with the touch screen. For example, the user may tap and hold on the beginning of the portion that the user would like to select on the example page content user interface using finger or stylus, and then indicate the selection of the portion by moving the finger or stylus to the end of the portion that the user would like to select.

While the description above provides an example mechanism of generating example user highlight inputs, it is noted that the scope of the present disclosure is not limited to the description above. In some examples, an example user highlight input may be generated through other means.

In some embodiments, an example user highlight input may be generated by an input/output circuitry (such as, but not limited to, the input/output circuitry 208 described above in connection with FIG. 2) and provided to the processing circuitry. Additionally, or alternatively, an example user highlight input may be generated by the processing circuitry.

If, at step/operation 406, the processing circuitry determines that the user highlight input is not received, the example method 400 returns back to step/operation 406. For example, if the user highlight input is not received at step/operation 406, the example method 400 may not proceed with rendering an updated page user interface at step/operation 408.

If, at step/operation 406, the processing circuitry determines that the user highlight input is received, the example method 400 proceeds to step/operation 408. At step/operation 408, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering an updated page user interface.

For example, an input/output circuitry may provide the user highlight input to the processing circuitry, and the processing circuitry may determine that the user highlight input is received when it receives the user highlight input from the input/output circuitry. Additionally, or alternatively, the processing circuitry may determine that the user highlight input is received based on user interactions with the page content user interface component as described above.

In some embodiments, the processing circuitry causes rendering an example updated page content user interface component in response to receiving a user highlight input associated with the page content user interface component. In some embodiments, the example updated page content user interface component comprises one or more highlighted page content user interface elements and one or more unhighlighted page content user interface elements.

For example, the one or more highlighted page content user interface elements may correspond to the portion of content (such as, but not limited to, texts, texts, tables, images, audio data, video data, links, and/or the like) that is selected by the user according to the user highlight input. In such an example, the one or more unhighlighted page content user interface elements may correspond to the portion of content (such as, but not limited to, texts, texts, tables, images, audio data, video data, links, and/or the like) that is not selected by the user according to the user highlight input.

In some embodiments, the example updated page content user interface may utilize one or more user interface features to visually distinguish the one or more highlighted page content user interface elements from the one or more unhighlighted page content user interface elements. For example, the one or more highlighted page content user interface elements may have a background color that is different from the background of the one or more unhighlighted page content user interface elements. Additionally, or alternatively, the one or more highlighted page content user interface elements may have a font size and/or style that is different from the font size and/or style of the one or more unhighlighted page content user interface elements. Additionally, or alternatively, one or more visual features of the highlighted page content user interface elements may be different from those of the unhighlighted page content user interface elements.

Referring back to FIG. 4, subsequent to, prior to, or simultaneously with step/operation 408, the example method 400 proceeds to step/operation 410. At step/operation 410, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering an example contextual menu user interface component.

In some embodiments, in response to receiving a user highlight input associated with the page content user interface component (similar to those described above), the processing circuitry causes rendering an example contextual menu user interface component. In some embodiments, in response to receiving a user highlight input associated with the page content user interface component, the processing circuitry may cause rendering of both an updated page content user interface component and a contextual menu user interface component.

As described above, the example contextual menu user interface component may display, illustrate, and/or indicate data and/or information associated with one or more operation options based at least in part on the content selected based on the user highlight input. For example, the example contextual menu user interface component comprises an issue trigger user interface element that triggers rendering of an example machine learning predicted issue creation user interface component. Additional details associated with example machine learning predicted issue creation user interface components are described herein.

In some embodiments, the example contextual menu user interface component is positioned adjacent to the one or more highlighted page content user interface elements. In some embodiments, the example contextual menu user interface component does not obscure any content associated with the one or more highlighted page content user interface elements. Such an example arrangement between the example contextual menu user interface component and the highlighted page content user interface elements provides technical benefits of improved user experience by enabling a user to retain context associated with the highlighted page content user interface elements when reviewing operation options from the example contextual menu user interface component. Additional details associated with example contextual menu user interface components are described herein.

Referring back to FIG. 4, subsequent and/or in response to step/operation 410, the example method 400 proceeds to step/operation 412. At step/operation 412, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) determines whether a user selection input is received.

As described above, a user selection input may indicate a selection of a user interface element by a user. In some embodiments, the processing circuitry may determine whether a user selection input associated with the issue trigger user interface element of the contextual menu user interface component is received.

For example, an example user selection input associated with the issue trigger user interface element may be generated based on user interactions with a computer mouse. In such an example, the user may position the mouse cursor on the issue trigger user interface element, and then click and release the left mouse button. Additionally, or alternatively, an example user selection input associated with the issue trigger user interface element may be generated based on user interactions with a computer keyboard. For example, the user may use one more keyboard shortcuts to indicate a selection of the issue trigger user interface element. Additionally, or alternatively, the example page content user interface component may be rendered on a touch screen, and the user selection input associated with the issue trigger user interface element may be generated based on user interactions with the touch screen. For example, the user may tap the issue trigger user interface element using finger or stylus.

If, at step/operation 412, the processing circuitry determines that the user selection input associated with the issue trigger user interface element of the contextual menu user interface component is not received, the example method 400 returns back to step/operation 412. For example, if the user selection input associated with the issue trigger user interface element of the contextual menu user interface component is not received at step/operation 412, the example method 400 may not proceed with rendering a machine learning predicted issue creation user interface component at step/operation 414.

If, at step/operation 412, the processing circuitry determines that the user selection input associated with the issue trigger user interface element of the contextual menu user interface component is received, the example method 400 proceeds to step/operation 414. At step/operation 414, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering an example machine learning predicted issue creation user interface component.

For example, an input/output circuitry may provide the user selection input to the processing circuitry, and the processing circuitry may determine that the user selection input is received when it receives the user selection input from the input/output circuitry. Additionally, or alternatively, the processing circuitry may determine that the user selection input is received based on user interactions with the issue trigger user interface element of the contextual menu user interface component as described above.

In some embodiments, the processing circuitry causes rendering an example machine learning predicted issue creation user interface component in response to receiving a user selection input associated with the issue trigger user interface element. As described above, the example machine learning predicted issue creation user interface component may display, illustrate, and/or indicate data and/or information that is predicted by one or more machine learning models. For example, the example machine learning predicted issue creation user interface component comprises one or more machine learning model predicted issue metadata user interface elements that are generated by one or more machine learning models based on the one or more highlighted page content user interface elements and the one or more unhighlighted page content user interface elements. In some embodiments, one or more machine learning model predicted issue metadata user interface elements indicate predicted issue field metadata and predicted issue value metadata that are associated with generating one or more issue data objects. Additional details associated with the predicted issue field metadata and the predicted issue value metadata are described herein.

In some embodiments, the machine learning predicted issue creation user interface component is positioned adjacent to and does not obscure the updated page content user interface component. Such an example arrangement between the machine learning predicted issue creation user interface component and the updated page content user interface component provides technical benefits of improved user experience by enabling a user to retain context associated with the page content user interface component (including the highlighted page content user interface elements and unhighlighted page content user interface elements) when reviewing predicted issue field metadata and predicted issue value metadata that are associated with generating one or more issue data objects. Additional details associated with example contextual menu user interface components are described herein.

Referring back to FIG. 4, subsequent and/or in response to step/operation 414, the example method 400 proceeds to step/operation 416 and ends.

Referring now to FIG. 5, an example visualization view illustrating an example page data object user interface 500 in accordance with some embodiments of the present disclosure is provided.

In the example shown in FIG. 5, the example page data object user interface 500 comprises an example page content user interface component 501, which displays, illustrates, and/or indicates data and/or information associated with the content of an example page data object (for example, the page data object for “GTM Strategy”).

In some embodiments, a page data object user interface may indicate at least one of a parent page data object, a sibling page data object, or a child page data object associated with the page data object. In the example shown in FIG. 5, the example page data object user interface 500 comprises an example page hierarchy user interface component 503, which displays a parent page data object (for example, the page data object for “Marketing strategy”) and several sibling page data objects (for example, the page data object for “Campaign workflow”, the page data object for “Project kickoff”, and the page data object for “New product launch plan”) of the example page data object (for example, the page data object for “GTM Strategy”).

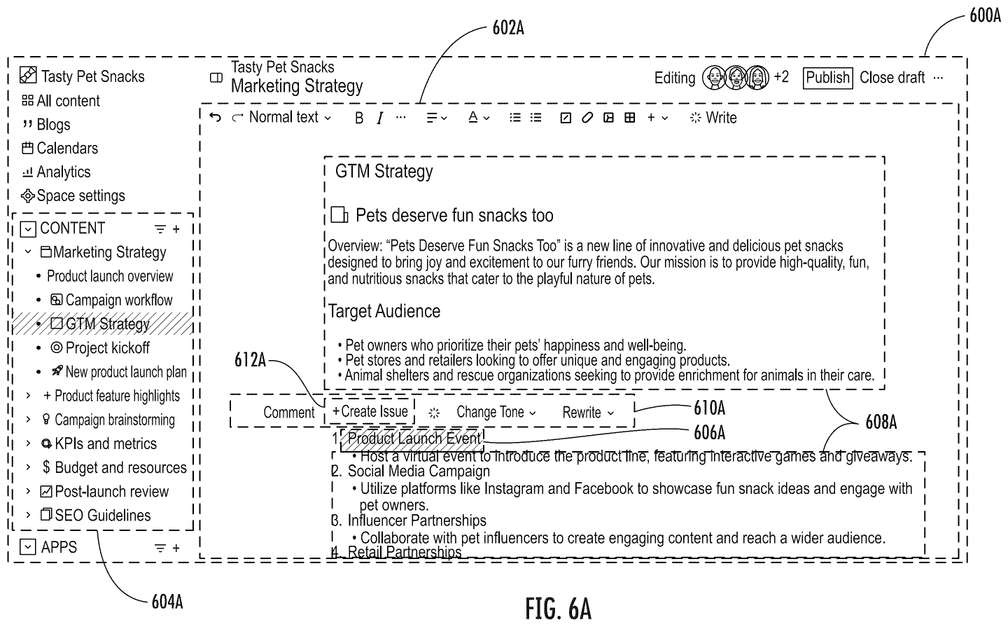

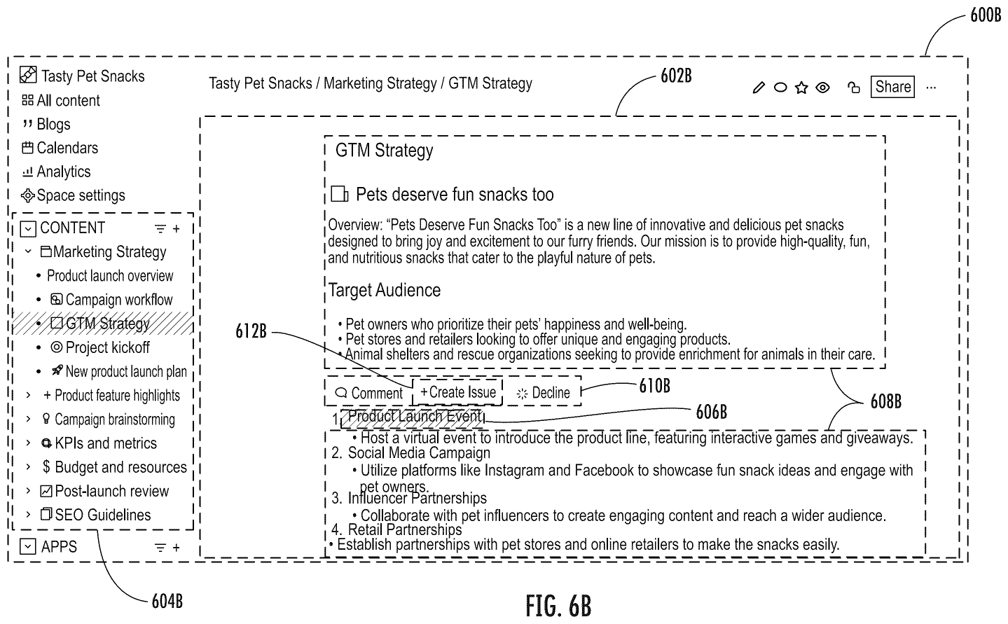

Referring now to FIG. 6A and FIG. 6B, example visualization views illustrating example page data object user interfaces in accordance with some embodiments of the present disclosure are provided. In particular, FIG. 6A illustrates an example page data object user interface in the view mode, and FIG. 6B illustrates an example page data object user interface in the edit mode. In some embodiments, the edit mode allows a user to edit content and data associated with the page data object shown on the example page data object user interface, while the view mode does not allow the user to edict content and data associated with the page data object.

Referring now to FIG. 6A, an example visualization view illustrating an example page data object user interface 600A in accordance with some embodiments of the present disclosure is provided.

In the example shown in FIG. 6A, the example page data object user interface 600A comprises an example updated page content user interface component 602A and an example page hierarchy user interface component 604A.

In some embodiments, the example updated page content user interface component 602A may be generated in response to receiving a user highlight input, similar to step/operation 406 and step/operation 408 described above in connection with FIG. 4.

For example, the example updated page content user interface component 602A comprises at least one highlighted page content user interface element 606A and at least one unhighlighted page content user interface element 608A that are generated based on the user highlight input. In such an example, the at least one highlighted page content user interface element 606A indicates that the content selected by the user includes the text “Product Launch Event” from the example updated page content user interface component 602A, while the at least one unhighlighted page content user interface element 608A indicates that contents that are not selected by the user from the example updated page content user interface component 602A.

In some embodiments, the example updated page content user interface component 602A comprises an example contextual menu user interface component 610A that is generated in response to the user highlight input. As described above, an example contextual menu user interface component displays, illustrates, and/or indicates data and/or information associated with one or more operation options based at least in part on the content selected by the user. In the example shown in FIG. 6A, the example contextual menu user interface component 610A comprises an example issue trigger user interface element 612A.

Referring now to FIG. 6B, an example visualization view illustrating an example page data object user interface 600B in accordance with some embodiments of the present disclosure is provided.

In the example shown in FIG. 6B, the example page data object user interface 600B comprises an example updated page content user interface component 602B and an example page hierarchy user interface component 604B.

In some embodiments, the example updated page content user interface component 602B may be generated in response to receiving a user highlight input, similar to step/operation 406 and step/operation 408 described above in connection with FIG. 4.

For example, the example updated page content user interface component 602B comprises at least one highlighted page content user interface element 606B and at least one unhighlighted page content user interface element 608B that are generated based on the user highlight input. In such an example, the at least one highlighted page content user interface element 606B indicates that the content selected by the user includes the text “Product Launch Event” from the example updated page content user interface component 602B, while the at least one unhighlighted page content user interface element 608B indicates that contents that are not selected by the user from the example updated page content user interface component 602B.

In some embodiments, the example updated page content user interface component 602B comprises an example contextual menu user interface component 610B that is generated in response to the user highlight input. As described above, an example contextual menu user interface component displays, illustrates, and/or indicates data and/or information associated with one or more operation options based at least in part on the content selected by the user. In the example shown in FIG. 6B, the example contextual menu user interface component 610B comprises an example issue trigger user interface element 612B.

As described above in connection with at least FIG. 4, example contextual menu user interface components shown in FIG. 6A and FIG. 6B provide technical benefits and advantages such as, but not limited to, improving speed of generating issue data objects based on page data objects, as well as usability of example page collaboration and issue management platforms.

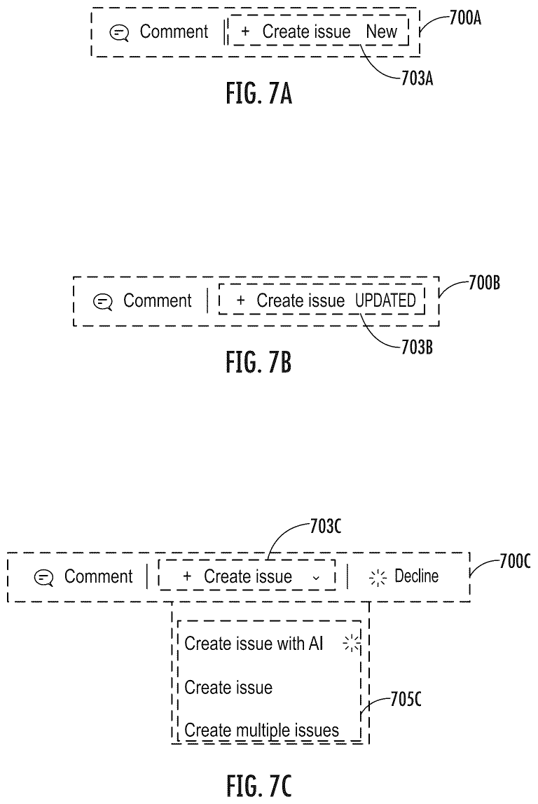

Referring now to FIG. 7A, FIG. 7B, and FIG. 7C, example contextual menu user interface components in accordance with some embodiments of the present disclosure are illustrated. In particular, FIG. 7A, FIG. 7B, and FIG. 7C illustrate example contextual menu user interface components that provide improved user experience.

In the example shown in FIG. 7A, the example contextual menu user interface component 700A comprises an example issue trigger user interface element 703A with a “new” status indicator that encourages a user to create an issue. Similarly, the example contextual menu user interface component 700B shown in FIG. 7B comprises an example issue trigger user interface element 703B with an “updated” status indicator.

Referring now to FIG. 7C, the example contextual menu user interface component 700C comprises an example issue trigger user interface element 703C. In response to receive a user selection input associated with the example issue trigger user interface element 703C, the example contextual menu user interface component 700C is updated to include an issue trigger option user interface element 705C that provide additional options for creating an issue data object such as, but not limited to, “create issue with AI,” “create issue,” and “create multiple issue.”

As described above in connection with at least FIG. 4, example contextual menu user interface components shown in FIG. 7A, FIG. 7B, and FIG. 7C provide technical benefits and advantages such as, but not limited to, improving speed of generating issue data objects based on page data objects, as well as usability of example page collaboration and issue management platforms.

### Example Training of Machine Learning Models

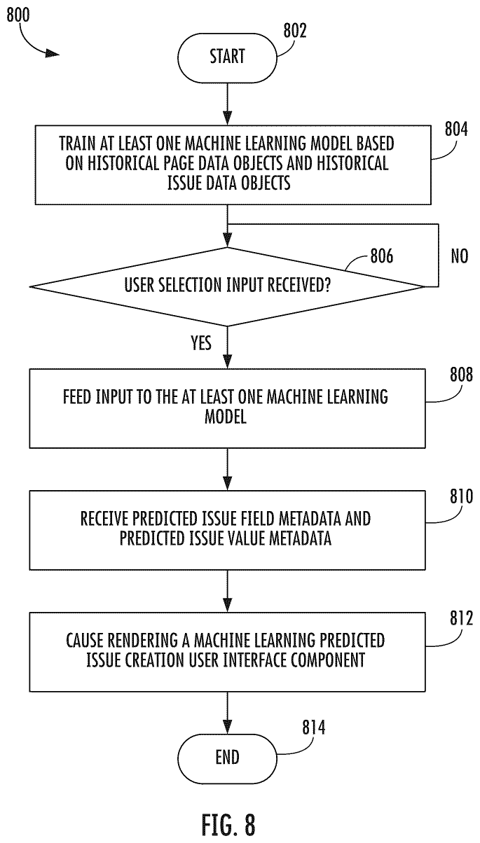

Referring now to FIG. 8, an example flow diagram illustrating example methods associated with generating example machine learning predicted issue creation user interface components in accordance with some embodiments of the present disclosure is provided.

For example, example methods illustrated in FIG. 8 resolve technical issues associated with page systems and issue systems and improve the functioning of page collaboration and issue management platforms by generating machine learning predicted issue creation user interface components. As such, example machine learning predicted issue creation user interface components in accordance with example methods illustrated in FIG. 8 improve speed of generating issue data objects based on page data objects, as well as usability of example page collaboration and issue management platforms in accordance with some embodiments of the present disclosure.

As described above, various embodiments of the present disclosure may utilize machine learning models to generate predicted data and/or information (such as, but not limited to, predicted issue field metadata and/or predicted issue value metadata). In some embodiments, the one or more machine learning models may include, but not limited to, natural language processing models and/or generative models.

For example, various embodiments of the present disclosure may utilize neural network based machine learning models such as, but not limited to, recurrent neural networks. In such an example, inputs (such as, but not limited to, content associated with the one or more highlighted page content user interface elements, content associated with the one or more unhighlighted page content user interface elements, and/or the like) may be tokenized and encoded, and then fed into an example recurrent neural network. The example recurrent neural network may process the tokenized and encoded input one by one, each time remembering the previously processed tokenized and encoded input. As such, implementing an example recurrent neural network in various embodiments of the present disclosure to generate predicted data (such as, but not limited to, predicted issue field metadata, predicted issue value metadata, and/or the like) provide the technical advantages of retaining the context from example page data objects when generating example issue data objects.

Additionally, or alternatively, various embodiments of the present disclosure may utilize transformer based machine learning models such as, but not limited to, generative pre-trained transformers. In such an example, inputs (such as, but not limited to, content associated with the one or more highlighted page content user interface elements, content associated with the one or more unhighlighted page content user interface elements, and/or the like) may be tokenized and encoded, and then fed into an example generative pre-trained transformer. The example generative pre-trained transformer may transform the tokenized and encoded input into high-dimensional vector embeddings to capture semantic and syntactic information of the tokenized and encoded input, and subsequently generate predicted data (such as, but not limited to, predicted issue field metadata, predicted issue value metadata, and/or the like) through transformer layers that includes self-attention mechanisms and feedforward networks.

Additionally, or alternatively, example embodiments of the present disclosure may utilize one or more additional and/or alternative machine learning models (such as, but not limited to, generative adversarial networks, bidirectional and autoregressive transformers, and/or the like).

In the example shown in FIG. 8, an example method 800 starts at step/operation 802 and then proceeds to step/operation 804. At step/operation 804, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) trains at least one machine learning model based on historical page data objects and historical issue data objects.

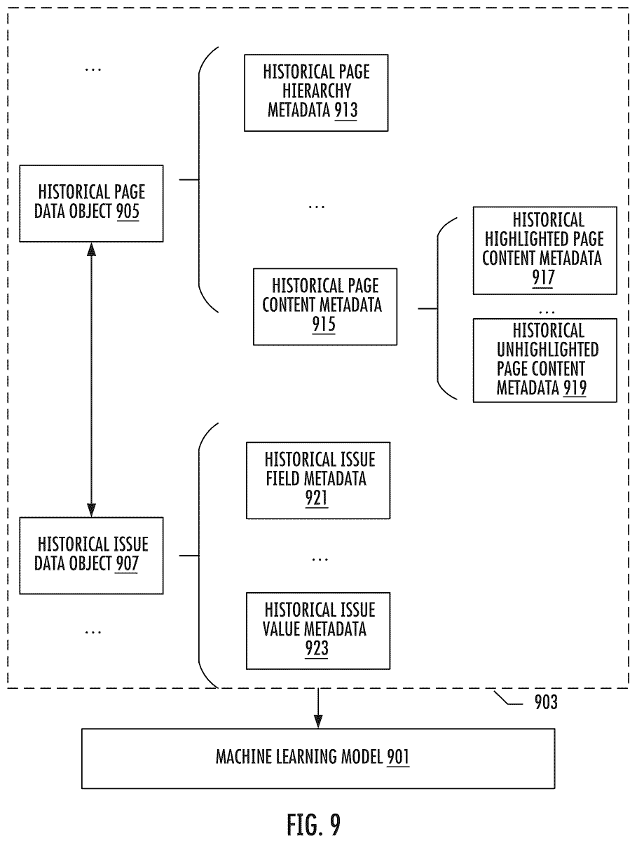

As described above, each historical issue data object is generated based at least in part on one or more historical page data objects. Referring now to FIG. 9, an example historical page data object 905 and an example historical issue data object 907 for training an example machine learning model 901 in accordance with some embodiments of the present disclosure are illustrated.

In the example shown in FIG. 9, the example machine learning model 901 is trained based at least on historical data objects 903 such as, but not limited to, a plurality of historical page data objects (such as the example historical page data object 905) and a plurality of historical issue data objects (such as the example historical issue data object 907).

In some embodiments, the example historical page data object 905 may comprise metadata such as, but not limited to, historical page hierarchy metadata 913, historical page content metadata 915, and/or the like. In some embodiments, the historical page content metadata 915 may comprise historical highlighted page content metadata 917 and historical unhighlighted page content metadata 919. In some embodiments, the example historical issue data object 907 may comprise metadata such as, but not limited to, historical issue field metadata 921, historical issue value metadata 923, and/or the like.

Various embodiments of the present disclosure may train one or more machine learning models to generate predicted data and/or information (such as, but not limited to, predicted issue field metadata, predicted issue value metadata, and/or the like).

For example, various embodiments of the present disclosure may train neural network based machine learning models such as, but not limited to, recurrent neural networks. In such an example, various embodiments of present disclosure may perform pre-processing of the historical data objects 903 to generate input-output pairs that each comprises an input sequence and an output sequence for training the recurrent neural networks. For example, the input sequence of input-output pairs may be generated based on applying tokenization of metadata associated with the example historical page data object 905 such as, but not limited to, historical page hierarchy metadata 913, historical page content metadata 915 (including, but not limited to, historical highlighted page content metadata 917 and historical unhighlighted page content metadata 919), and/or the like. Continuing in this example, the output sequence of the input-output pairs may be generated based on applying tokenization of metadata associated with the example historical issue data object 907 such as, but not limited to, historical issue field metadata 921, historical issue value metadata 923, and/or the like. In some embodiments, the input sequence may be further converted into vectors for feeding into the machine learning model 901 for training (such as, but not limited to, through one-hot encoding, word embedding, and/or the like). During training, the example recurrent neural network may generate predicted issue field metadata and/or predicted issue value metadata, and compare the predicted issue field metadata and/or predicted issue value metadata with the output sequence from the input-output pairs. Based on the comparison, the example recurrent neural network may adjust one or more weights (such as, but not limited to, input weights, recurrent weights, output weights, and/or the like) so as to minimize error and improve the accuracy in predicting issue field metadata, issue value metadata, and/or the like.

Additionally, or alternatively, various embodiments of the present disclosure may train transformer based machine learning models such as, but not limited to, generative transformers. Similar to the example described above in connection with training neural network based machine learning models, various embodiments of present disclosure may perform pre-processing of the historical data objects 903 to generate input-output pairs that each comprises an input sequence and an output sequence for training generative transformers. For example, the input sequence of input-output pairs may be generated based on applying tokenization of metadata associated with the example historical page data object 905 such as, but not limited to, historical page hierarchy metadata 913, historical page content metadata 915 (including, but not limited to, historical highlighted page content metadata 917 and historical unhighlighted page content metadata 919), and/or the like. Continuing in this example, the output sequence of the input-output pairs may be generated based on applying tokenization of metadata associated with the example historical issue data object 907 such as, but not limited to, historical issue field metadata 921, historical issue value metadata 923, and/or the like. In some embodiments, padding and/or truncating operations may be performed on the input sequence so that the length of the input sequence is adjusted according to the fixed length input as required by the generative transformer. In some embodiments, positional encoding operations may be performed to inject position information associated with the tokens in the input sequence. During training, the example generative transformer may generate predicted issue field metadata and/or predicted issue value metadata, and compare the predicted issue field metadata and/or predicted issue value metadata with the output sequence from the input-output pairs. Based on the comparison, the example generative transformers may adjust one or more weights (such as, but not limited to, embedding layer weights (such as, but not limited to, word embedding weights, positional encoding weights, and/or the like), self-attention mechanism weights, multi-head attention weights, and/or the like) so as to minimize error and improve the accuracy in predicting issue field metadata, issue value metadata, and/or the like.

While the description above provides an example of training machine learning models to generate predicted issue field metadata and predicted issue value metadata, it is noted that the scope of the present disclosure is not limited to the description above. Various embodiments of the present disclosure may implement one or more additional and/or alternative machine learning models, and/or one or more additional and/or alternative ways of training machine learning models.

In some embodiments, by training the at least one machine learning model based on historical page data objects and historical issue data objects, various embodiment of the present disclosure provide technical benefits and advantages such as, but not limited to, improved accuracy in predicting metadata associated with an issue data object to be generated based on the page data object.

Referring back to FIG. 8, subsequent and/or in response to step/operation 804, the example method 800 proceeds to step/operation 806. At step/operation 806, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) determines whether a user selection input is received.

Similar to the examples described above in connection with at least step/operation 412 of FIG. 4, the processing circuitry may determine whether a user selection input associated with the issue trigger user interface element of the contextual menu user interface component is received.

If, at step/operation 806, the processing circuitry determines that the user selection input associated with the issue trigger user interface element of the contextual menu user interface component is not received, the example method 800 returns back to step/operation 806. For example, if the user selection input associated with the issue trigger user interface element of the contextual menu user interface component is not received at step/operation 806, the example method 800 may not proceed with feeding input to the at least one machine learning model at step/operation 808.

If, at step/operation 806, the processing circuitry determines that the user selection input associated with the issue trigger user interface element of the contextual menu user interface component is received, the example method 800 proceeds to step/operation 808. At step/operation 808, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) feeds input to the at least one machine learning model.

In some embodiments, input to the at least one machine learning model may comprise data and/or information associated with the one or more highlighted page content user interface elements and the one or more unhighlighted page content user interface elements. For example, input to the at least one machine learning modem may comprise texts, tables, images, audio data, video data, and/or the like that is associated with the one or more highlighted page content user interface elements, as well as texts, tables, images, audio data, video data, and/or the like that is associated with the one or more unhighlighted page content user interface elements.

As described above, the page data object user interface may comprise a page hierarchy user interface component. For example, the page data object user interface may indicate at least one of a parent page data object, a sibling page data object, or a child page data object associated with the page data object. In some embodiments, input to the at least one machine learning model may comprise data and/or information associated with at least one of the parent page data object, the sibling page data object, or the child page data object. For example, input to the at least one machine learning modem may comprise texts, tables, images, audio data, video data, and/or the like that is associated with a parent page data object, texts, tables, images, audio data, video data, and/or the like that is associated with a sibling page data object, and/or texts, tables, images, audio data, video data, and/or the like that is associated with a child page data object.

While the description above provides examples of input to the at least one machine learning model, it is noted that the scope of the present disclosure is not limited to the description above. In some examples, one or more additional and/or alternative inputs may be provided to the at least one machine learning model.

In some embodiments, one or more pre-processing operations may be applied to the input to be fed into the at least one machine learning model. For example, input may be tokenized and encoded prior to being fed into the at least one machine learning model, similar to the various examples described above.

Referring back to FIG. 8, subsequent and/or in response to step/operation 808, the example method 800 proceeds to step/operation 810. At step/operation 810, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) receives predicted issue field metadata and predicted issue value metadata.

In some embodiments, the processing circuitry generates predicted issue field metadata and/or predicted issue value metadata based at least in part on one or more machine learning models, the one or more highlighted page content user interface elements and the one or more unhighlighted page content user interface elements. For example, the one or more machine learning models may be trained to generate predicted issue field metadata and/or predicted issue value metadata based on the highlighted page content user interface elements and the unhighlighted page content user interface elements, similar to various examples described above in connection with at least step/operation 804 of FIG. 8 and at least FIG. 9. In such an example, the processing circuitry receives predicted issue field metadata and predicted issue value metadata from the at least one machine learning model.

As described above, the page data object user interface may comprise a page hierarchy user interface component. In some embodiments, the page data object user interface may indicate at least one of a parent page data object, a sibling page data object, or a child page data object associated with the page data object. In some embodiments, the processing circuitry generates predicted issue field metadata and/or predicted issue value metadata based at least in part on one or more machine learning models, the one or more highlighted page content user interface elements, the one or more unhighlighted page content user interface elements, and at least one of a parent page data object, a sibling page data object, or a child page data object associated with the page data object. For example, the one or more machine learning models may be trained to generate predicted issue field metadata and/or predicted issue value metadata based on highlighted page content user interface elements, unhighlighted page content user interface elements, and at least one of a parent page data object, a sibling page data object, or a child page data object associated with the page data object, similar to various examples described above in connection with at least step/operation 804 of FIG. 8 and at least FIG. 9. In such an example, the processing circuitry receives predicted issue field metadata and predicted issue value metadata from the at least one machine learning model.

Referring back to FIG. 8, subsequent and/or in response to step/operation 810, the example method 800 proceeds to step/operation 812. At step/operation 812, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering a machine learning predicted issue creation user interface component.

In some embodiments, the machine learning predicted issue creation user interface component comprises one or more machine learning model predicted issue metadata user interface elements. In some embodiments, the one or more machine learning model predicted issue metadata user interface elements indicate predicted issue field metadata and/or predicted issue value metadata that are received from the at least one machine learning model at step/operation 810. As described above, the predicted issue field metadata and/or the predicted issue value metadata of the one or more machine learning model predicted issue metadata user interface elements may be generated based on highlighted page content user interface elements and unhighlighted page content user interface elements. Additionally, or alternatively, as described above, the predicted issue field metadata and/or the predicted issue value metadata of the one or more machine learning model predicted issue metadata user interface elements may be generated based on highlighted page content user interface elements, unhighlighted page content user interface elements, and further based on at least one of the parent page data object, the sibling page data object, or the child page data object.

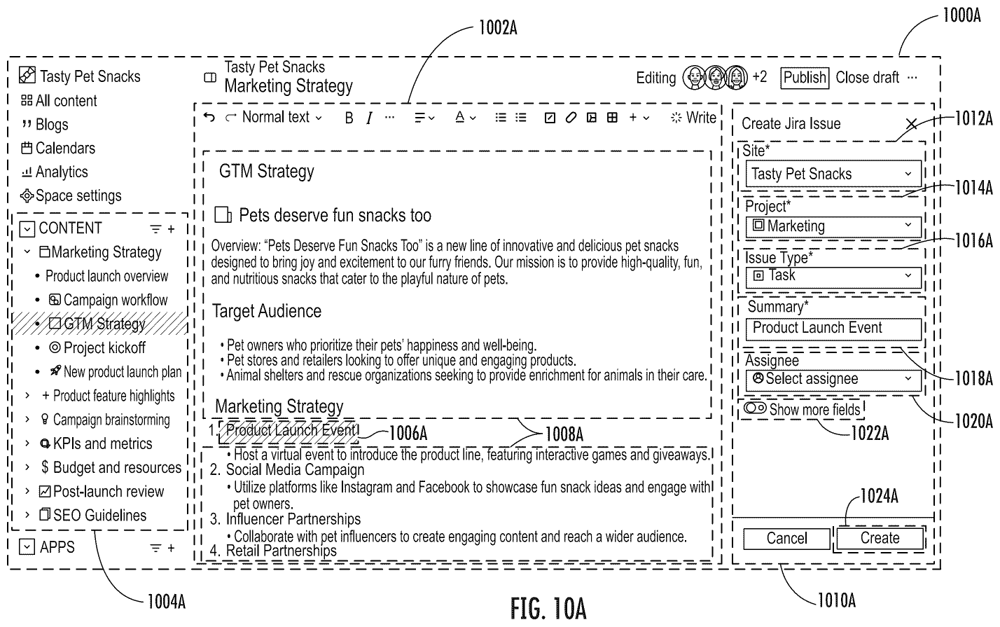

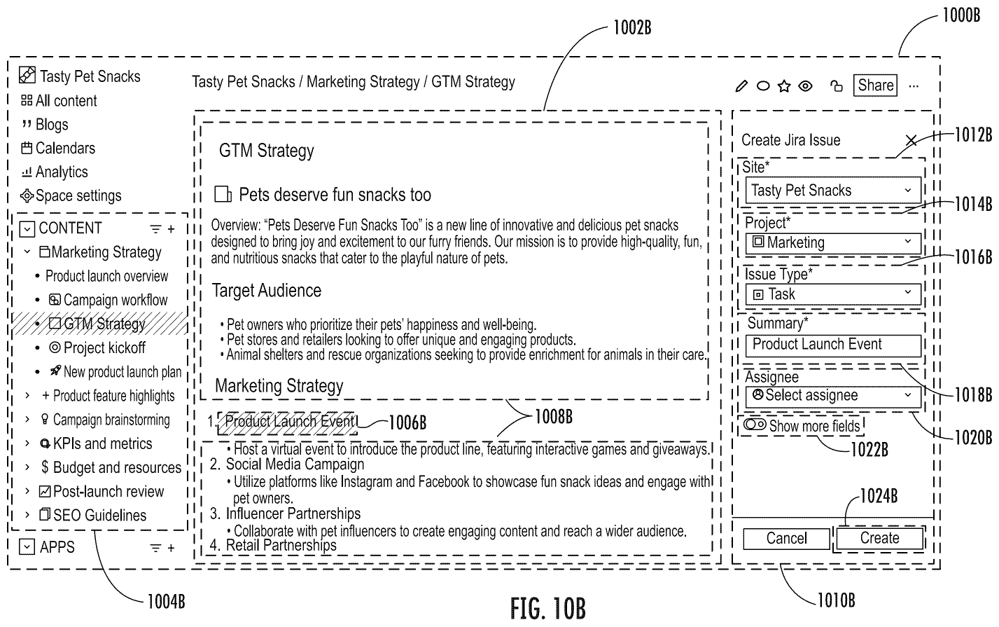

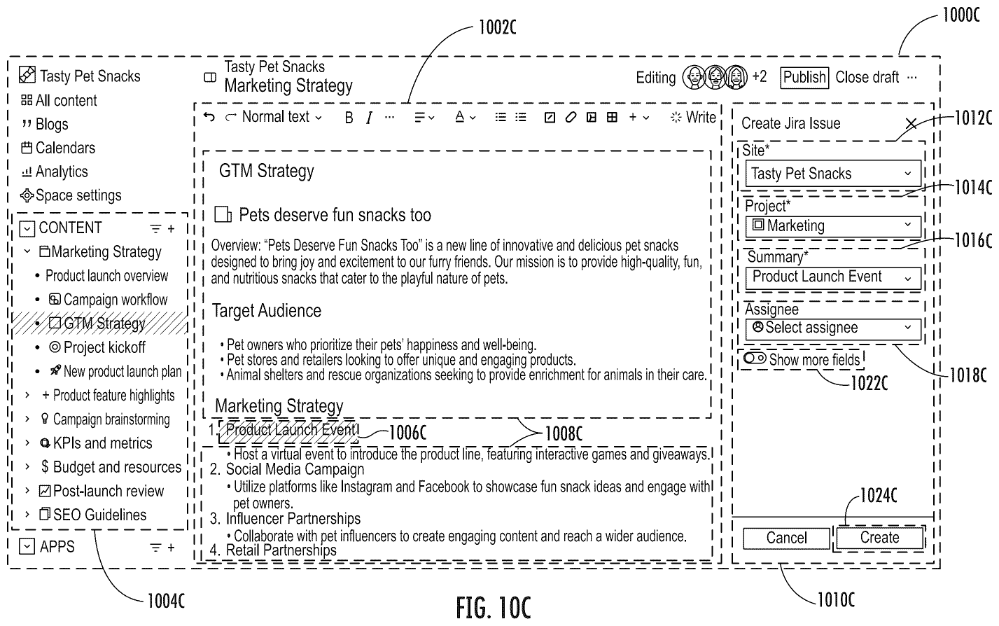

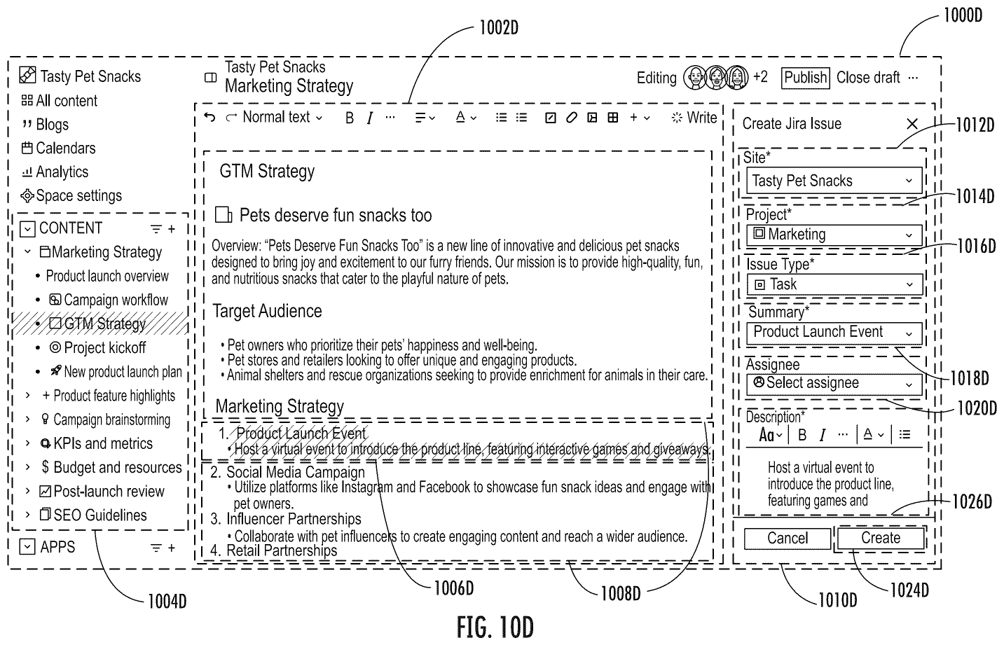

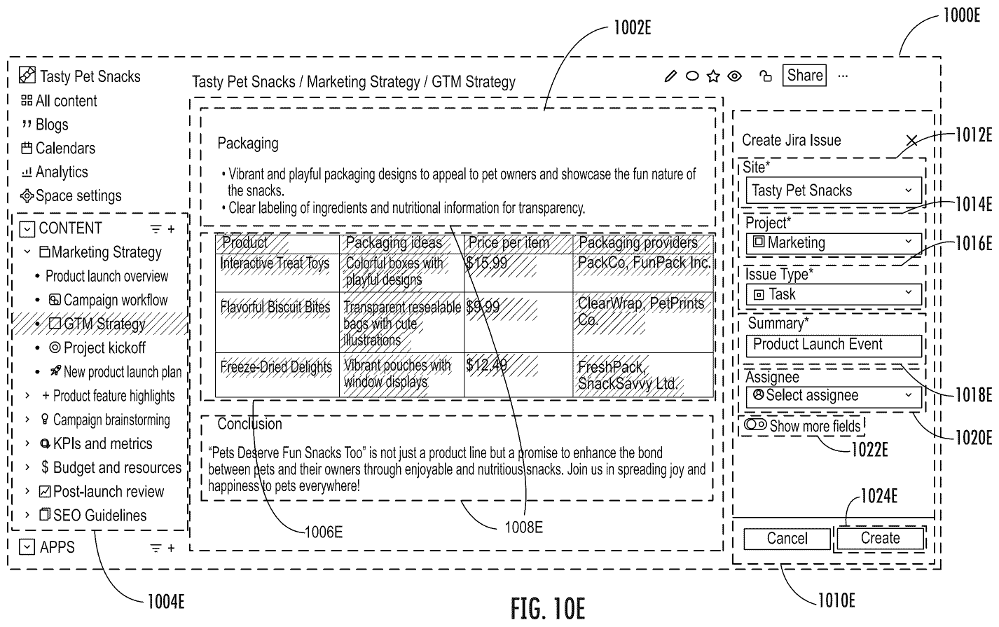

Examples of machine learning predicted issue creation user interface components and machine learning model predicted issue metadata user interface elements are illustrated in connection with at least FIG. 10A to FIG. 10E.

Referring back to FIG. 8, subsequent and/or in response to step/operation 812, the example method 800 proceeds to step/operation 814 and ends.

Referring now to FIG. 10A to FIG. 10E, example page data object user interfaces in accordance with some embodiments of the present disclosure are illustrated. In particular, FIG. 10A to FIG. 10E highlight various examples of machine learning predicted issue creation user interface components.

Referring now to FIG. 10A, an example visualization view illustrating an example page data object user interface 1000A in accordance with some embodiments of the present disclosure is provided. In particular, the example page data object user interface 1000A is in the edit mode.

In the example shown in FIG. 10A, the example page data object user interface 1000A comprises an example updated page content user interface component 1002A, an example page hierarchy user interface component 1004A, and an example machine learning predicted issue creation user interface component 1010A.

In some embodiments, the example updated page content user interface component 1002A may be generated in response to receiving a user highlight input, similar to step/operation 406 and step/operation 408 described above in connection with FIG. 4.

For example, the example updated page content user interface component 1002A comprises at least one highlighted page content user interface element 1006A and at least one unhighlighted page content user interface element 1008A that are generated based on the user highlight input. In such an example, the at least one highlighted page content user interface element 1006A indicates that the content selected by the user includes the text “Product Launch Event” from the example updated page content user interface component 1002A, while the at least one unhighlighted page content user interface element 1008A indicates that contents that are not selected by the user from the example updated page content user interface component 1002A.

In some embodiments, the example machine learning predicted issue creation user interface component 1010A may be generated in response to receiving a user selection input associated with the issue trigger user interface element of the contextual menu user interface component, similar to step/operation 412 and step/operation 414 described above in connection with FIG. 4 as well as step/operation 806 and step/operation 808 described above in connection with FIG. 8.

In the example shown in FIG. 10A, the example machine learning predicted issue creation user interface component 1010A comprises a plurality of machine learning model predicted issue metadata user interface elements such as, but not limited to, a machine learning model predicted issue metadata user interface element 1012A, a machine learning model predicted issue metadata user interface element 1014A, a machine learning model predicted issue metadata user interface element 1016A, a machine learning model predicted issue metadata user interface element 1018A, a machine learning model predicted issue metadata user interface element 1020A.

As described above, the one or more machine learning model predicted issue metadata user interface elements indicate predicted issue field metadata and predicted issue value metadata, which are generated by the processing circuitry based at least in part on one or more machine learning models, the one or more highlighted page content user interface elements and the one or more unhighlighted page content user interface elements. For example, the machine learning model predicted issue metadata user interface element 1012A indicates predicted issue field metadata (“site”) and predicted issue value metadata (“Tasty Pet Snack”). As another example, the machine learning model predicted issue metadata user interface element 1014A indicates predicted issue field metadata (“project”) and predicted issue value metadata (“Marketing”). As another example, the machine learning model predicted issue metadata user interface element 1016A indicates predicted issue field metadata (“issue type”) and predicted issue value metadata (“Task”). As another example, the machine learning model predicted issue metadata user interface element 1018A indicates predicted issue field metadata (“summary”) and predicted issue value metadata (“Product Launch Event”). As another example, the machine learning model predicted issue metadata user interface element 1020A indicates predicted issue field metadata (“assignee”).

In some embodiments, the example machine learning predicted issue creation user interface component 1010A may comprise one or more additional user interface elements. In the example shown in FIG. 10A, the example machine learning predicted issue creation user interface component 1010A comprises an additional issue field metadata toggle user interface element 1022A, as well as an issue confirmation user interface element 1024A.

For example, a user may provide a user input to trigger the additional issue field metadata toggle user interface element 1022A to cause the example machine learning predicted issue creation user interface component 1010A to display additional metadata fields associated with the to be generated issue data object, and the user may provide input for these additional metadata fields. Additionally, or alternatively, a user may provide user input to remove one or more machine learning model predicted issue metadata user interface elements from the example machine learning predicted issue creation user interface component 1010A. In some embodiments, a user may provide a user confirmation input through the issue confirmation user interface element 1024A to confirm that an issue data object associated with the page data object can be generated based on the predicted metadata fields, predicted metadata values, and/or user provided input, additional details of which are described herein. Example machine learning predicted issue creation user interface component 1010A provides technical benefits and advantages such as, but not limited to, improving speed of generating issue data objects based on page data objects, as well as usability of example page collaboration and issue management platforms.

Referring now to FIG. 10B, an example visualization view illustrating an example page data object user interface 1000B in accordance with some embodiments of the present disclosure is provided. Compared with the example page data object user interface 1000A shown in FIG. 10A, the example page data object user interface 1000B shown in FIG. 10B is in view mode.

In the example shown in FIG. 10B, the example page data object user interface 1000B comprises an example updated page content user interface component 1002B, an example page hierarchy user interface component 1004B, and an example machine learning predicted issue creation user interface component 1010B.

In some embodiments, the example updated page content user interface component 1002B may be generated in response to receiving a user highlight input, similar to step/operation 406 and step/operation 408 described above in connection with FIG. 4.

For example, the example updated page content user interface component 1002B comprises at least one highlighted page content user interface element 1006B and at least one unhighlighted page content user interface element 1008B that are generated based on the user highlight input. In such an example, the at least one highlighted page content user interface element 1006B indicates that the content selected by the user includes the text “Product Launch Event” from the example updated page content user interface component 1002B, while the at least one unhighlighted page content user interface element 1008B indicates that contents that are not selected by the user from the example updated page content user interface component 1002B.

In some embodiments, the example machine learning predicted issue creation user interface component 1010B may be generated in response to receiving a user selection input associated with the issue trigger user interface element of the contextual menu user interface component, similar to step/operation 412 and step/operation 414 described above in connection with FIG. 4 as well as step/operation 806 and step/operation 808 described above in connection with FIG. 8.

In the example shown in FIG. 10B, the example machine learning predicted issue creation user interface component 1010B comprises a plurality of machine learning model predicted issue metadata user interface elements such as, but not limited to, a machine learning model predicted issue metadata user interface element 1012B, a machine learning model predicted issue metadata user interface element 1014B, a machine learning model predicted issue metadata user interface element 1016B, a machine learning model predicted issue metadata user interface element 1018B, a machine learning model predicted issue metadata user interface element 1020B.

As described above, the one or more machine learning model predicted issue metadata user interface elements indicate predicted issue field metadata and predicted issue value metadate, which are generated by the processing circuitry based at least in part on one or more machine learning models, the one or more highlighted page content user interface elements and the one or more unhighlighted page content user interface elements. For example, the machine learning model predicted issue metadata user interface element 1012A indicates predicted issue field metadata (“site”) and predicted issue value metadata (“Tasty Pet Snack”). As another example, the machine learning model predicted issue metadata user interface element 1014A indicates predicted issue field metadata (“project”) and predicted issue value metadata (“Marketing”). As another example, the machine learning model predicted issue metadata user interface element 1016A indicates predicted issue field metadata (“issue type”) and predicted issue value metadata (“Task”). As another example, the machine learning model predicted issue metadata user interface element 1018A indicates predicted issue field metadata (“summary”) and predicted issue value metadata (“Product Launch Event”). As another example, the machine learning model predicted issue metadata user interface element 1020A indicates predicted issue field metadata (“assignee”).

In some embodiments, the example machine learning predicted issue creation user interface component 1010B may comprise one or more additional user interface elements. In the example shown in FIG. 10B, the example machine learning predicted issue creation user interface component 1010B comprises an additional issue field metadata toggle user interface element 1022B, as well as an issue confirmation user interface element 1024B.

For example, a user may provide a user input to trigger the additional issue field metadata toggle user interface element 1022B to cause the example machine learning predicted issue creation user interface component 1010B to display additional metadata fields associated with the to be generated issue data object, and the user may provide input for these additional metadata fields. Additionally, or alternatively, a user may provide user input to remove one or more machine learning model predicted issue metadata user interface elements from the example machine learning predicted issue creation user interface component 1010B. In some embodiments, a user may provide a user confirmation input through the issue confirmation user interface element 1024B to confirm that an issue data object associated with the page data object can be generated based on the predicted metadata fields, predicted metadata values, and/or user provided input, additional details of which are described herein. Example machine learning predicted issue creation user interface component 1010B provides technical benefits and advantages such as, but not limited to, improving speed of generating issue data objects based on page data objects, as well as usability of example page collaboration and issue management platforms.

Referring now to FIG. 10C, an example visualization view illustrating an example page data object user interface 1000C in accordance with some embodiments of the present disclosure is provided. In particular, the example page data object user interface 1000C illustrates less machine learning model predicted issue metadata user interface elements as compared to those of the example page data object user interface 1000A shown in FIG. 10A. In such an example, the at least one machine learning model may predict less issue field metadata and issue value metadata than those of FIG. 10A based on the page data object.

In the example shown in FIG. 10C, the example page data object user interface 1000C comprises an example updated page content user interface component 1002C, an example page hierarchy user interface component 1004C, and an example machine learning predicted issue creation user interface component 1010C.

In some embodiments, the example updated page content user interface component 1002C comprises at least one highlighted page content user interface element 1006C and at least one unhighlighted page content user interface element 1008C.

In some embodiments, the example machine learning predicted issue creation user interface component 1010C comprises a plurality of machine learning model predicted issue metadata user interface elements such as, but not limited to, a machine learning model predicted issue metadata user interface element 1012C, a machine learning model predicted issue metadata user interface element 1014C, a machine learning model predicted issue metadata user interface element 1016C, and a machine learning model predicted issue metadata user interface element 1018C.

For example, the machine learning model predicted issue metadata user interface element 1012C indicates predicted issue field metadata (“project”) and predicted issue value metadata (“Marketing”). As another example, the machine learning model predicted issue metadata user interface element 1014C indicates predicted issue field metadata (“issue type”) and predicted issue value metadata (“Task”). As another example, the machine learning model predicted issue metadata user interface element 1016C indicates predicted issue field metadata (“summary”) and predicted issue value metadata (“Product Launch Event”). As another example, the machine learning model predicted issue metadata user interface element 1018C indicates predicted issue field metadata (“assignee”).

In comparison with the example machine learning predicted issue creation user interface component 1010A shown in FIG. 10A, the example machine learning predicted issue creation user interface component 1010C shown in FIG. 10C does not include a machine learning model predicted issue metadata user interface element that indicates predicted issue field metadata “site.” For example, one or more one machine learning models may determine that the users associated with the page data object only have access to one site and/or that only one site associated with an issue data object can be linked to the page data object (for example, based on the one or more highlighted page content user interface elements, the one or more unhighlighted page content user interface elements, the page hierarchy user interface component, and/or the like). In such an example the one or more one machine learning models determine that it is not necessary to generate a machine learning model predicted issue metadata user interface element that indicates predicted issue field metadata “site.” As such, the example machine learning predicted issue creation user interface component 1010C shown in FIG. 10C does not include a machine learning model predicted issue metadata user interface element that indicates predicted issue field metadata “site.”

In some embodiments, the example machine learning predicted issue creation user interface component 1010C may comprise one or more additional user interface elements. In the example shown in FIG. 10C, the example machine learning predicted issue creation user interface component 1010C comprises an additional issue field metadata toggle user interface element 1022C, as well as an issue confirmation user interface element 1024C.

For example, a user may provide a user input to trigger the additional issue field metadata toggle user interface element 1022C to cause the example machine learning predicted issue creation user interface component 1010C to display additional metadata fields associated with the to be generated issue data object, and the user may provide input for these additional metadata fields. Additionally, or alternatively, a user may provide user input to remove one or more machine learning model predicted issue metadata user interface elements from the example machine learning predicted issue creation user interface component 1010C. In some embodiments, a user may provide a user confirmation input through the issue confirmation user interface element 1024C to confirm that an issue data object associated with the page data object can be generated based on the predicted metadata fields, predicted metadata values, and/or user provided input, additional details of which are described herein. Example machine learning predicted issue creation user interface component 1010C provides technical benefits and advantages such as, but not limited to, improving speed of generating issue data objects based on page data objects, as well as usability of example page collaboration and issue management platforms.

Referring now to FIG. 10D, an example visualization view illustrating an example page data object user interface 1000D in accordance with some embodiments of the present disclosure is provided. In particular, the example page data object user interface 1000C illustrates more machine learning model predicted issue metadata user interface elements as compared to those of the example page data object user interface 1000A shown in FIG. 10A. In such an example, the at least one machine learning model predicts more issue field metadata and issue value metadata than those of FIG. 10A based on the page data object.

In the example shown in FIG. 10D, the example page data object user interface 1000D comprises an example updated page content user interface component 1002D, an example page hierarchy user interface component 1004D, and an example machine learning predicted issue creation user interface component 1010D.

In some embodiments, the example updated page content user interface component 1002D comprises at least one highlighted page content user interface element 1006D and at least one unhighlighted page content user interface element 1008D.

In some embodiments, the example machine learning predicted issue creation user interface component 1010D comprises a plurality of machine learning model predicted issue metadata user interface elements such as, but not limited to, a machine learning model predicted issue metadata user interface element 1012D, a machine learning model predicted issue metadata user interface element 1014D, a machine learning model predicted issue metadata user interface element 1016D, a machine learning model predicted issue metadata user interface element 1018D, a machine learning model predicted issue metadata user interface element 1020D, and a machine learning model predicted issue metadata user interface element 1026D.

As described above, the one or more machine learning model predicted issue metadata user interface elements indicate predicted issue field metadata and predicted issue value metadata, which are generated by the processing circuitry based at least in part on one or more machine learning models, the one or more highlighted page content user interface elements and the one or more unhighlighted page content user interface elements. For example, the machine learning model predicted issue metadata user interface element 1012D indicates predicted issue field metadata (“site”) and predicted issue value metadata (“Tasty Pet Snack”). As another example, the machine learning model predicted issue metadata user interface element 1014D indicates predicted issue field metadata (“project”) and predicted issue value metadata (“Marketing”). As another example, the machine learning model predicted issue metadata user interface element 1016D indicates predicted issue field metadata (“issue type”) and predicted issue value metadata (“Task”). As another example, the machine learning model predicted issue metadata user interface element 1018D indicates predicted issue field metadata (“summary”) and predicted issue value metadata (“Product Launch Event”). As another example, the machine learning model predicted issue metadata user interface element 1020D indicates predicted issue field metadata (“assignee”). As another example, the machine learning model predicted issue metadata user interface element 1026D indicates predicted issue field metadata (“description”).

In comparison with the example machine learning predicted issue creation user interface component 1010A shown in FIG. 10A, the example machine learning predicted issue creation user interface component 1010D shown in FIG. 10D includes a machine learning model predicted issue metadata user interface element that indicates predicted issue field metadata “description.” For example, one or more one machine learning models may determine that the predicted issue field metadata “description” is related to the issue data object to be generated because the issue data object requires a description (for example, the issue data object may describe a bug, a task, or a story). As such, the example machine learning predicted issue creation user interface component 1010D shown in FIG. 10D includes a machine learning model predicted issue metadata user interface element 1026D indicates predicted issue field metadata (“description”).

In some embodiments, the example machine learning predicted issue creation user interface component 1010D may comprise one or more additional user interface elements. In the example shown in FIG. 10D, the example machine learning predicted issue creation user interface component 1010D comprises an issue confirmation user interface element 1024D.

For example, a user may provide user input to remove one or more machine learning model predicted issue metadata user interface elements from the example machine learning predicted issue creation user interface component 1010D. In some embodiments, a user may provide a user confirmation input through the issue confirmation user interface element 1024D to confirm that an issue data object associated with the page data object can be generated based on the predicted metadata fields, predicted metadata values, and/or user provided input, additional details of which are described herein. Example machine learning predicted issue creation user interface component 1010D provides technical benefits and advantages such as, but not limited to, improving speed of generating issue data objects based on page data objects, as well as usability of example page collaboration and issue management platforms.

Referring now to FIG. 10E, an example visualization view illustrating an example page data object user interface 1000E in accordance with some embodiments of the present disclosure is provided. Compare with the examples shown in FIG. 10A to FIG. 10D, the example page data object user interface 1000E illustrates an example where the content selected by the user includes a table.

In the example shown in FIG. 10E, the example page data object user interface 1000E comprises an example updated page content user interface component 1002E, an example page hierarchy user interface component 1004E, and an example machine learning predicted issue creation user interface component 1010E.

In some embodiments, the example updated page content user interface component 1002E may be generated in response to receiving a user highlight input, similar to step/operation 406 and step/operation 408 described above in connection with FIG. 4. In the example shown in FIG. 10E, the user highlight input is associated with table data from the page data object.

For example, the example updated page content user interface component 1002E comprises at least one highlighted page content user interface element 1006E and at least one unhighlighted page content user interface element 1008E that are generated based on the user highlight input. In such an example, the at least one highlighted page content user interface element 1006E indicates that the content selected by the user includes the table from the example updated page content user interface component 1002E, while the at least one unhighlighted page content user interface element 1008E indicates that contents that are not selected by the user from the example updated page content user interface component 1002E.

In some embodiments, the example machine learning predicted issue creation user interface component 1010E may be generated in response to receiving a user selection input associated with the issue trigger user interface element of the contextual menu user interface component, similar to step/operation 412 and step/operation 414 described above in connection with FIG. 4 as well as step/operation 806 and step/operation 808 described above in connection with FIG. 8.

In some embodiments, the example machine learning predicted issue creation user interface component 1010E comprises a plurality of machine learning model predicted issue metadata user interface elements such as, but not limited to, a machine learning model predicted issue metadata user interface element 1012E, a machine learning model predicted issue metadata user interface element 1014E, a machine learning model predicted issue metadata user interface element 1016E, a machine learning model predicted issue metadata user interface element 1018E and, a machine learning model predicted issue metadata user interface element 1020E.

As described above, the one or more machine learning model predicted issue metadata user interface elements indicate predicted issue field metadata and predicted issue value metadata, which are generated by the processing circuitry based at least in part on one or more machine learning models, the one or more highlighted page content user interface elements and the one or more unhighlighted page content user interface elements. For example, the machine learning model predicted issue metadata user interface element 1012E indicates predicted issue field metadata (“site”) and predicted issue value metadata (“Tasty Pet Snack”). As another example, the machine learning model predicted issue metadata user interface element 1014E indicates predicted issue field metadata (“project”) and predicted issue value metadata (“Marketing”). As another example, the machine learning model predicted issue metadata user interface element 1016E indicates predicted issue field metadata (“issue type”) and predicted issue value metadata (“Task”). As another example, the machine learning model predicted issue metadata user interface element 1018E indicates predicted issue field metadata (“summary”) and predicted issue value metadata (“Product Launch Event”). As another example, the machine learning model predicted issue metadata user interface element 1020E indicates predicted issue field metadata (“assignee”).

In some embodiments, the example machine learning predicted issue creation user interface component 1010E may comprise one or more additional user interface elements. In the example shown in FIG. 10E, the example machine learning predicted issue creation user interface component 1010E comprises an additional issue field metadata toggle user interface element 1022E, as well as an issue confirmation user interface element 1024E.

For example, a user may provide a user input to trigger the additional issue field metadata toggle user interface element 1022E to cause the example machine learning predicted issue creation user interface component 1010E to display additional metadata fields associated with the to be generated issue data object, and the user may provide input for these additional metadata fields. Additionally, or alternatively, a user may provide user input to remove one or more machine learning model predicted issue metadata user interface elements from the example machine learning predicted issue creation user interface component 1010E. In some embodiments, a user may provide a user confirmation input through the issue confirmation user interface element 1024E to confirm that an issue data object associated with the page data object can be generated based on the predicted metadata fields, predicted metadata values, and/or user provided input, additional details of which are described herein. Example machine learning predicted issue creation user interface component 1010E provides technical benefits and advantages such as, but not limited to, improving speed of generating issue data objects based on page data objects, as well as usability of example page collaboration and issue management platforms.

### Example Generate of Updated Page User Interface Component

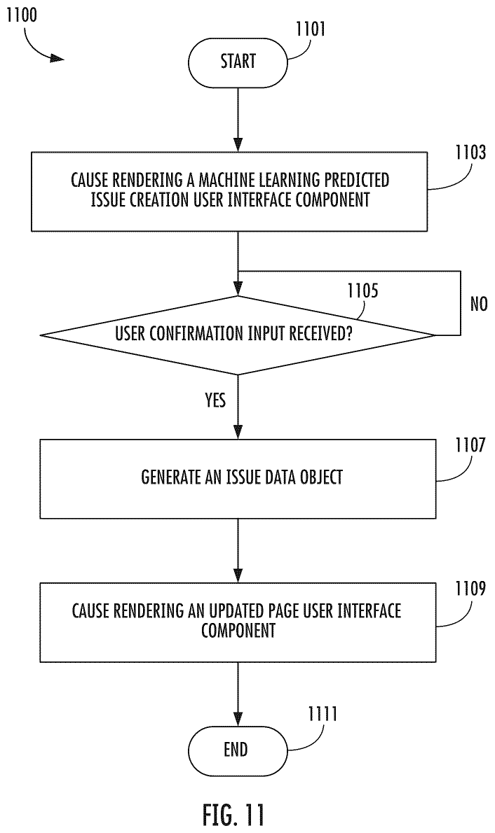

Referring now to FIG. 11, an example flow diagram illustrating example methods associated with generating example updated page user interface components in accordance with some embodiments of the present disclosure is provided.

For example, example methods illustrated in FIG. 11 resolve technical issues associated with page systems and issue systems and improve the functioning of page collaboration and issue management platforms by generating updated page user interface components that link issue data objects to page data objects. As such, example updated page user interface components in accordance with example methods illustrated in FIG. 11 improve speed of generating issue data objects based on page data objects, as well as usability of example page collaboration and issue management platforms in accordance with some embodiments of the present disclosure.

In the example shown in FIG. 11, an example method 1100 starts at step/operation 1101 and then proceeds to step/operation 1103. At step/operation 1103, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering a machine learning predicted issue creation user interface component.

Similar to step/operation 812 of FIG. 8 and various examples illustrated herein, the machine learning predicted issue creation user interface component comprises one or more machine learning model predicted issue metadata user interface elements. In some embodiments, the one or more machine learning model predicted issue metadata user interface elements indicate predicted issue field metadata and/or predicted issue value metadata that are generated by at least one machine learning model, similar to various examples described herein.

Referring back to FIG. 11, subsequent and/or in response to step/operation 1103, the example method 1100 proceeds to step/operation 1105. At step/operation 1105, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) determines whether a user confirmation input is received.

In some embodiments, a user confirmation input may indicate a confirmation from a user to generate an issue data object. For example, the machine learning predicted issue creation user interface component rendered at step/operation 1103 may comprise an issue confirmation user interface element. In such an example, the processing circuitry may determine whether the user selects the issue confirmation user interface element from the machine learning predicted issue creation user interface component.

For example, an example user confirmation input associated with the issue confirmation user interface element may be generated based on user interactions with a computer mouse. In such an example, the user may position the mouse cursor on the issue confirmation user interface element, and then click and release the left mouse button. Additionally, or alternatively, an example user selection input associated with the issue confirmation user interface element may be generated based on user interactions with a computer keyboard. For example, the user may use one more keyboard shortcuts to indicate a selection of the issue confirmation user interface element. Additionally, or alternatively, the example page content user interface component may be rendered on a touch screen, and the user confirmation input associated with the issue confirmation user interface element may be generated based on user interactions with the touch screen. For example, the user may tap the issue confirmation user interface element using finger or stylus.

If, at step/operation 1105, the processing circuitry determines that the user confirmation input is not received, the example method 1100 returns back to step/operation 1105. For example, if the user confirmation input associated with the issue confirmation user interface element of the machine learning predicted issue creation user interface component is not received at step/operation 1105, the example method 1100 may not proceed with generating an issue data object at step/operation 1107.

If, at step/operation 1105, the processing circuitry determines that the user confirmation input is received, the example method 1100 proceeds to step/operation 1107. At step/operation 1107, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) generates an issue data object.

For example, the processing circuitry may generate the issue data object based at least in part on the predicted issue field metadata and the predicted issue value metadata that are indicated in the one or more machine learning model predicted issue metadata user interface elements. Additionally, or alternatively, a user may provide one or more edits to the predicted issue field metadata and predicted issue value metadata, and the processing circuitry may generate the issue data object based on the predicted issue field metadata and the predicted issue value metadata, and user edits.

Referring back to FIG. 11, subsequent and/or in response to step/operation 1107, the example method 1100 proceeds to step/operation 1109. At step/operation 1109, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes rendering an updated page user interface component.

In some embodiments, the updated page user interface component may comprise an updated page content user interface component that comprises an issue link user interface element linking the page content to the issue data object generated at step/operation 1107. Additionally, or alternatively, the updated page user interface component comprises an issue generation announcement user interface element, which indicates that an issue data object is generated and comprises a link to the issue data object.

Referring back to FIG. 11, subsequent and/or in response to step/operation 1109, the example method 1100 proceeds to step/operation 1111 and ends.

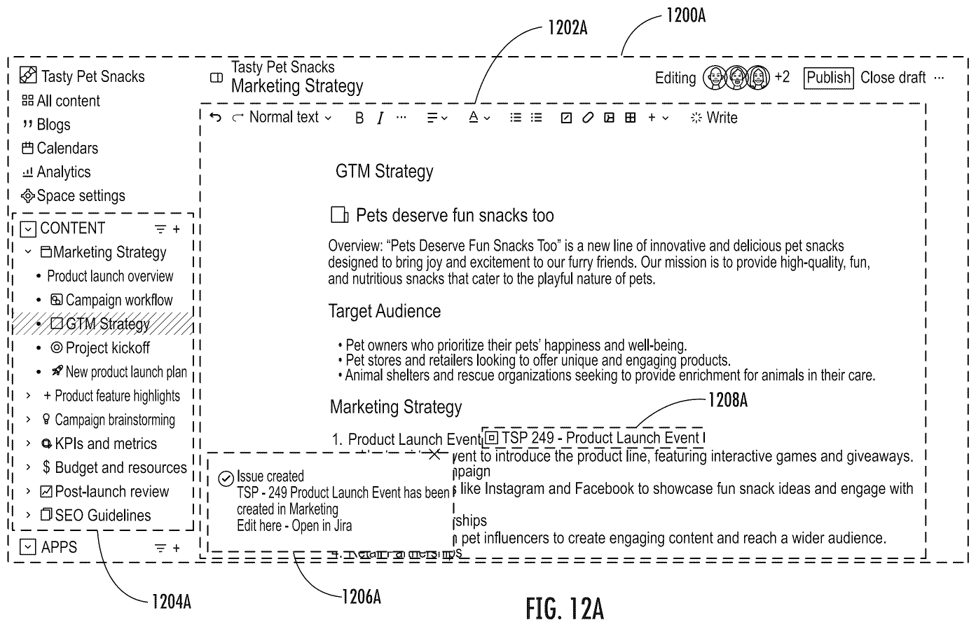

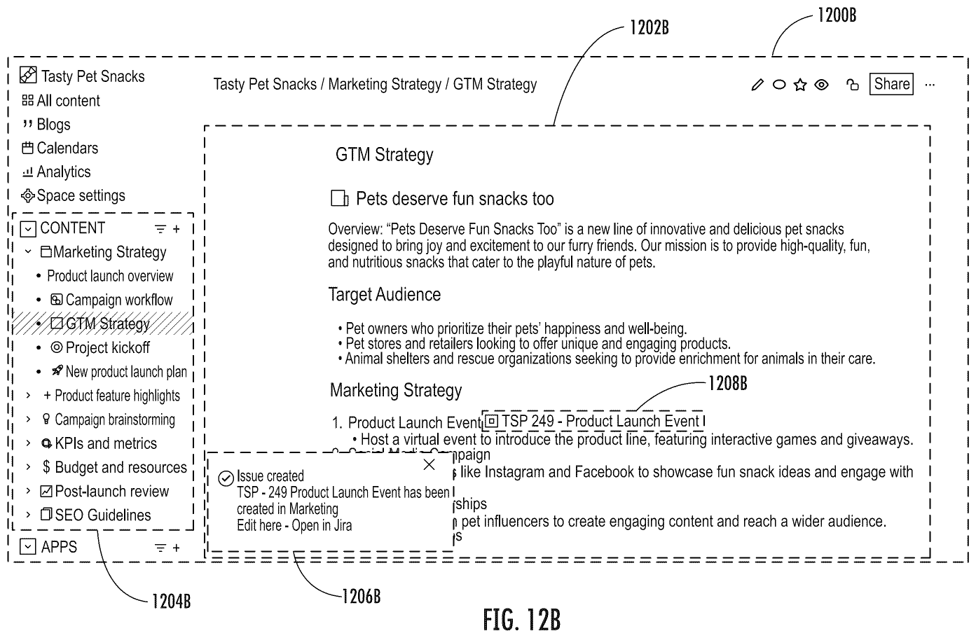

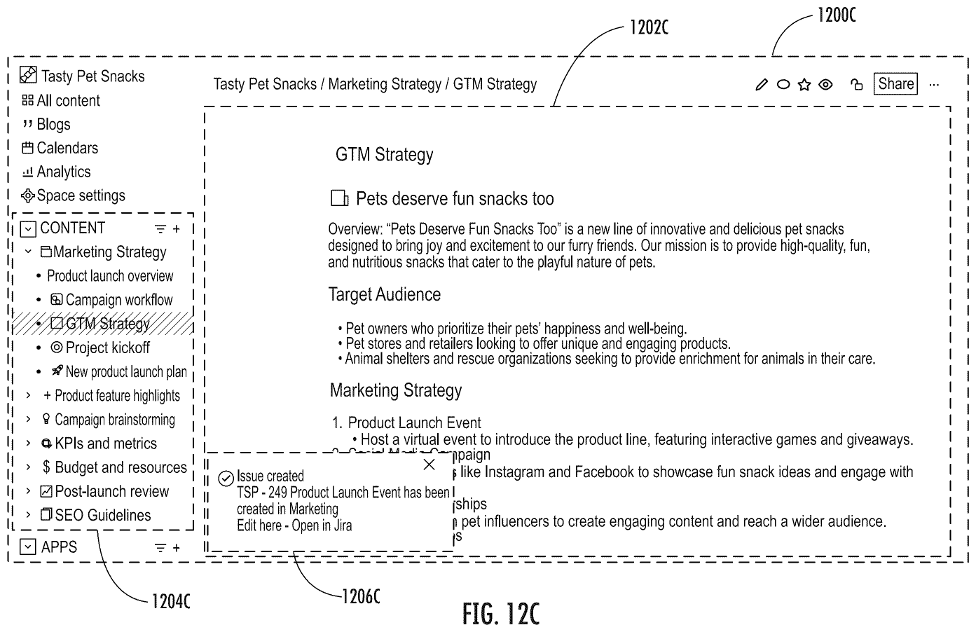

Referring now to FIG. 12A, an example visualization view illustrating an example page data object user interface 1200A in accordance with some embodiments of the present disclosure is provided. In particular, the example page data object user interface 1200A is in the edit mode.

In the example shown in FIG. 12A, the example page data object user interface 1200A comprises an example page hierarchy user interface component 1204A and an example updated page content user interface component 1202A. In the example shown in FIG. 12A, the example updated page content user interface component 1202A comprises an issue link user interface element 1208A linking the page data object user interface 1200A to an issue data object generated based on the content from the page data object user interface 1200A. For example, the issue link user interface element 1208A is positioned adjacent to and does not obscure the content that was highlighted by the user for generating the issue data object. The example updated page content user interface component 1202A also comprises an issue generation announcement user interface element 1206A that indicates an issue data object is generated and comprises a link to the issue data object. The issue link user interface element 1208A and the issue generation announcement user interface element 1206A provide technical benefits and advantages such as, but not limited to, improving usability of example page collaboration and issue management platforms by allowing users to easily navigate between contents from the page data object and contents from the issue data object that is generated based on the page data object.

Referring now to FIG. 12B, an example visualization view illustrating an example page data object user interface 1200B in accordance with some embodiments of the present disclosure is provided. Compared with the example page data object user interface 1200A shown in FIG. 12A, the example page data object user interface 1200B shown in FIG. 12B is in view mode.

In the example shown in FIG. 12B, the example page data object user interface 1200B comprises an example page hierarchy user interface component 1204B and an example updated page content user interface component 1202B. In the example shown in FIG. 12B, the example updated page content user interface component 1202B comprises an issue link user interface element 1208B linking the page data object user interface 1200B to an issue data object generated based on the content from the page data object user interface 1200B. For example, the issue link user interface element 1208B is positioned adjacent to and does not obscure the content that was highlighted by the user for generating the issue data object. The example updated page content user interface component 1202B also comprises an issue generation announcement user interface element 1206B that indicates an issue data object is generated and comprises a link to the issue data object. The issue link user interface element 1208B and the issue generation announcement user interface element 1206B provide technical benefits and advantages such as, but not limited to, improving usability of example page collaboration and issue management platforms by allowing users to easily navigate between contents from the page data object and contents from the issue data object that is generated based on the page data object.

Referring now to FIG. 12C, an example visualization view illustrating an example page data object user interface 1200C in accordance with some embodiments of the present disclosure is provided.

In the example shown in FIG. 12C, the example page data object user interface 1200C comprises an example page hierarchy user interface component 1204C and an example updated page content user interface component 1202C. In the example shown in FIG. 12C, the example updated page content user interface component 1202C does not comprise an issue link user interface element but comprises an issue generation announcement user interface element 1206C that indicates an issue data object is generated and comprises a link to the issue data object. The issue generation announcement user interface element 1206C provides technical benefits and advantages such as, but not limited to, improving usability of example page collaboration and issue management platforms by allowing users to easily navigate between contents from the page data object and contents from the issue data object that is generated based on the page data object.

### Additional Implementation Details

Although example processing systems have been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. A computer-readable storage medium can be, or be included in, a computer-readable storage device, a computer-readable storage substrate, a random or serial access memory array or device, or a combination of one or more of them. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a data object repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer needs not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., an LCD monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a user computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML (Hypertext Markup Language) page) to a user computing device (e.g., for purposes of displaying information/data to and receiving user input from a user interacting with the user computing device). Information/data generated at the user computing device (e.g., a result of the user interaction) can be received from the user computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising program code, the at least one non-transitory memory and the program code configured to, with the at least one processor, cause the apparatus to at least:
cause rendering a page data object user interface comprising a page content user interface component associated with a page data object;
in response to receiving a user highlight input associated with the page content user interface component, cause rendering:
an updated page content user interface component comprising one or more highlighted page content user interface elements and one or more unhighlighted page content user interface elements, and
a contextual menu user interface component positioned adjacent to the one or more highlighted page content user interface elements and comprising an issue trigger user interface element,
in response to receiving a user selection input associated with the issue trigger user interface element, cause rendering:
a machine learning predicted issue creation user interface component comprising one or more machine learning model predicted issue metadata user interface elements based on the one or more highlighted page content user interface elements and the one or more unhighlighted page content user interface elements.

2. The apparatus of claim 1, wherein the machine learning predicted issue creation user interface component is positioned adjacent to and does not obscure the updated page content user interface component.

3. The apparatus of claim 1, wherein the one or more machine learning model predicted issue metadata user interface elements indicate predicted issue field metadata and predicted issue value metadata.

4. The apparatus of claim 3, wherein the at least one non-transitory memory and the program code are configured to, with the at least one processor, cause the apparatus to:
generate the predicted issue field metadata and the predicted issue value metadata based at least in part on one or more machine learning models, the one or more highlighted page content user interface elements and the one or more unhighlighted page content user interface elements.

5. The apparatus of claim 4, wherein the one or more machine learning models are trained based on a plurality of historical page data objects and a plurality of historical issue data objects.

6. The apparatus of claim 1, wherein the page data object user interface comprises a page hierarchy user interface component indicating at least one of a parent page data object, a sibling page data object, or a child page data object associated with the page data object.

7. The apparatus of claim 6, wherein the one or more machine learning model predicted issue metadata user interface elements are further based on at least one of the parent page data object, the sibling page data object, or the child page data object.

8. A computer-implemented method comprising:
receiving a user highlight input associated with a page content user interface component of a page data object user interface associated with a page data object;
in response to receiving the user highlight input, causing rendering:
an updated page content user interface component comprising one or more highlighted page content user interface elements and one or more unhighlighted page content user interface elements, and
a contextual menu user interface component comprising an issue trigger user interface element,
receiving a user selection input associated with the issue trigger user interface element;
in response to receiving the user selection input, causing rendering:
a machine learning predicted issue creation user interface component comprising one or more machine learning model predicted issue metadata user interface elements based on the one or more highlighted page content user interface elements and the one or more unhighlighted page content user interface elements.

9. The computer-implemented method of claim 8, wherein the machine learning predicted issue creation user interface component is positioned adjacent to and does not obscure the updated page content user interface component.

10. The computer-implemented method of claim 8, wherein each of the one or more machine learning model predicted issue metadata user interface elements indicate predicted issue field metadata and predicted issue value metadata.

11. The computer-implemented method of claim 10 further comprising:
generating the predicted issue field metadata and the predicted issue value metadata based at least in part on one or more machine learning models, the one or more highlighted page content user interface elements and the one or more unhighlighted page content user interface elements.

12. The computer-implemented method of claim 11, wherein the one or more machine learning models are trained based on a plurality of historical page data objects and a plurality of historical issue data objects.

13. The computer-implemented method of claim 8, wherein the page data object user interface comprises a page hierarchy user interface component indicating at least one of a parent page data object, a sibling page data object, or a child page data object associated with the page data object.

14. The computer-implemented method of claim 13, wherein the one or more machine learning model predicted issue metadata user interface elements are further based on at least one of the parent page data object, the sibling page data object, or the child page data object.

15. A computer program product comprising at least one non-transitory computer-readable storage medium having computer-readable program code portions stored therein, the computer-readable program code portions comprising an executable portion configured to:
cause rendering a page data object user interface comprising a page content user interface component associated with a page data object;
in response to receiving a user highlight input associated with the page content user interface component, cause rendering one or more highlighted page content user interface elements, one or more unhighlighted page content user interface elements, a contextual menu user interface component; and
in response to receiving a user selection input associated with an issue trigger user interface element of the contextual menu user interface component, cause rendering a machine learning predicted issue creation user interface component comprising one or more machine learning model predicted issue metadata user interface elements.

16. The computer program product of claim 15, wherein each of the one or more machine learning model predicted issue metadata user interface elements indicate predicted issue field metadata and predicted issue value metadata.

17. The computer program product of claim 16, wherein the executable portion is configured to:
generate the predicted issue field metadata and the predicted issue value metadata based at least in part on one or more machine learning models, the one or more highlighted page content user interface elements and the one or more unhighlighted page content user interface elements.

18. The computer program product of claim 17, wherein the one or more machine learning models are trained based on a plurality of historical page data objects and a plurality of historical issue data objects.

19. The computer program product of claim 16, wherein the page data object user interface comprises a page hierarchy user interface component indicating at least one of a parent page data object, a sibling page data object, or a child page data object associated with the page data object.

20. The computer program product of claim 19, wherein the one or more machine learning model predicted issue metadata user interface elements are further based on at least one of the parent page data object, the sibling page data object, or the child page data object.
